(19) United States
(12) Patent Application Publication
(10) Pub. No.: US 2006/0242324 A1
(43) Pub. Date: Oct. 26, 2006

(54) Data replacement output apparatus and method

(76) Inventors: Akihiro Tanaka, Osaka-shi (JP); Toshiya Mori, Osaka (JP); Hideki Kagemoto, Nara (JP); Koichiro Yamaguchi, Osaka (JP); Yoshihisa Terada, Osaka (JP)

Correspondence Address: SNELL & WILMER L.L.P., 600 ANTON BOULEVARD, SUITE 1400, COSTA MESA, CA, 92626, US

(21) Appl. No.: 10/526,509

(22) PCT Filed: Sep. 22, 2003
(86) PCT No.: PCT/JP03/12065

§ 371 Date: May 8, 2006

(30) Foreign Application Priority Data
Sep. 20, 2002 (JP) 2002-274539

(51) Int. Cl. G06F 15/16

(52) U.S. Cl. 709/246

(57) ABSTRACT

The data replacement output apparatus 10 determines whether to perform a sequential output of replacement data based on a comparison between (i) the number of units of data constituting replacement object data received during a time period and (ii) the number of units of data constituting replacement data output during the time period. The determination is made each time replacement object data is received while the sequential output of data is not performed. If it determines to perform the sequential output, the data replacement output apparatus 10 outputs replacement data each time data constituting a data stream is received, and outputs non-replacement-object data each time data constituting non-replacement-object data is received while the sequential output is not performed; if it determines not to perform the sequential output, it outputs non-replacement-object data each time a unit of data constituting the data stream is received.

### TECHNICAL FIELD

The present invention relates to a data replacement output apparatus that receives data from outside, replaces part of the received data with corresponding data, and outputs data with the replacement.

### BACKGROUND ART

Some years ago, BS (Broadcasting Satellite) digital broadcasting using the broadcasting satellite was started in Japan. It is planned that terrestrial digital broadcasting using ground waves will be started in the end of 2003, and that within several years, the terrestrial digital broadcasting will displace the analog terrestrial broadcasting completely.

The terrestrial digital broadcasting provides viewers with data broadcast programs that are composed of character information and/or still pictures, as well as conventional broadcast programs composed of video data and audio data. In broadcasting of the data broadcast programs, material data constituting the data broadcast programs is transmitted by the DSM-CC data carousel transmission method.

The DSM-CC data carousel transmission method is specified in the international standard ISO/IEC 13818-6. More specifically, in the DSM-CC data carousel transmission method, material data constituting a data broadcast program is cyclically and repeatedly transmitted in predetermined units.

The viewers of the terrestrial digital broadcasting therefore can obtain, through a data broadcast program, additional information to a conventional broadcast program while the conventional broadcast program is broadcast, such as weather report or certain types of information related to the conventional broadcast program.

On the other hand, the contents of the weather report or news provided by the data broadcast programs need to be changed in accordance with the locality of the area in which such information is provided. For example, for the viewers living in the Western area in Japan, the weather report of the Eastern area is not necessary, but a detailed weather report of the Western area is desirable.

Also, each local area needs to be provided with the news of the local area.

Conventionally, local stations that receive a broadcast program from a key station, replace part of the received broadcast program with partial programs uniquely prepared for the local area.

Patent Document 1 discloses a technology for replacing part of the received broadcast program with partial programs uniquely prepared for local areas. According to Patent Document 1, pre- and post-identification codes are respectively attached to the start and end of the material data of a commercial so that a boundary between a post-identification code and a pre-identification code is detected. The sending station sends a commercial material data to the receiving stations together with a signal indicating a detected boundary, with as much delay as is suggested by the boundary detection signal. Each receiving station replaces the received commercial material data with another commercial material data having been prepared by the receiving station while synchronizing the boundary detection signal with the synchronization signal produced in the receiving station.

The above described technology has solved a problem that viewers catch a glimpse of the commercial material data sent from the sending station, which is a portion thereof not replaced with the commercial material data prepared by the receiving station.

Patent Document 1: Japanese Laid-Open Patent Application No. 2001-045371

However, the above-described conventional replacing technology, which is presumed to be applied to the analog broadcasting, cannot be applied to the terrestrial digital broadcasting to replace material data of data broadcast programs with corresponding data since the terrestrial digital broadcasting differs from the analog broadcasting in the broadcast program transmission method and the data structure of the broadcast program material data.

Also, when a data broadcast program broadcast by a key station differs from a data broadcast program broadcast by a receiving station in data size of the material data, the key station and the local station must use different bandwidths to broadcast the material data of their data broadcast programs in the same cycle.

### DISCLOSURE OF THE INVENTION

It is an object of the present invention to provide data replacement output apparatus and method that replace part of received data with corresponding data and output data with the replacement, while inputting and outputting data at the same speed.

The above object can be achieved by a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data replacement output apparatus comprising: a determining unit operable to determine whether to perform a sequential output of a predetermined number of units of data constituting the replacement data, based on a result of comparison between (i) a total number of units of data constituting the replacement object data that have been received during a time period from a reference time to a current time and (ii) a total number of units of data constituting the replacement data that have been output during the time period, the determination being made each time a unit of data constituting the replacement object data is received while the sequential output of data is not performed; and a data output unit operable to, if the determining unit determines to perform the sequential output of data, perform the sequential output of data by outputting a unit of data constituting the replacement data each time a unit of data constituting the data stream is received, operable to output a unit of data constituting the non-replacement-object data each time a unit of data constituting the non-replacement-object data is received while the sequential output of data is not performed, and operable to, if the determining unit determines not to perform the sequential output of data, output a unit of data constituting the non-replacement-object data each time a unit of data constituting the data stream is received.

The above object can also be achieved by a data replacement output method for use in a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data replacement output method comprising: a determining step for determining whether to perform a sequential output of a predetermined number of units of data constituting the replacement data, based on a result of comparison between (i) a total number of units of data constituting the replacement object data that have been received during a time period from a reference time to a current time and (ii) a total number of units of data constituting the replacement data that have been output during the time period, the determination being made each time a unit of data constituting the replacement object data is received while the sequential output of data is not performed; and a data output step for, if the determining step determines to perform the sequential output of data, performing the sequential output of data by outputting a unit of data constituting the replacement data each time a unit of data constituting the data stream is received, outputting a unit of data constituting the non-replacement-object data each time a unit of data constituting the non-replacement-object data is received while the sequential output of data is not performed, and if the determining step determines not to perform the sequential output of data, outputting a unit of data constituting the non-replacement-object data each time a unit of data constituting the data stream is received.

The above object can also be achieved by a data replacement output control program for use in a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data replacement output control program comprising: a determining step for determining whether to perform a sequential output of a predetermined number of units of data constituting the replacement data, based on a result of comparison between (i) a total number of units of data constituting the replacement object data that have been received during a time period from a reference time to a current time and (ii) a total number of units of data constituting the replacement data that have been output during the time period, the determination being made each time a unit of data constituting the replacement object data is received while the sequential output of data is not performed; and a data output step for, if the determining step determines to perform the sequential output of data, performing the sequential output of data by outputting a unit of data constituting the replacement data each time a unit of data constituting the data stream is received, outputting a unit of data constituting the non-replacement-object data each time a unit of data constituting the non-replacement-object data is received while the sequential output of data is not performed, and if the determining step determines not to perform the sequential output of data, outputting a unit of data constituting the non-replacement-object data each time a unit of data constituting the data stream is received.

The above object can also be achieved by a computer-readable recording medium recording therein a data replacement output control program for use in a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data replacement output control program comprising: a determining step for determining whether to perform a sequential output of a predetermined number of units of data constituting the replacement data, based on a result of comparison between (i) a total number of units of data constituting the replacement object data that have been received during a time period from a reference time to a current time and (ii) a total number of units of data constituting the replacement data that have been output during the time period, the determination being made each time a unit of data constituting the replacement object data is received while the sequential output of data is not performed; and a data output step for, if the determining step determines to perform the sequential output of data, performing the sequential output of data by outputting a unit of data constituting the replacement data each time a unit of data constituting the data stream is received, outputting a unit of data constituting the non-replacement-object data each time a unit of data constituting the non-replacement-object data is received while the sequential output of data is not performed, and if the determining step determines not to perform the sequential output of data, outputting a unit of data constituting the non-replacement-object data each time a unit of data constituting the data stream is received.

With the above-described construction, the data replacement output apparatus replaces part of received data with corresponding data and outputs data with the replacement, while inputting and outputting data at the same speed. Accordingly, data is transmitted at the same speed both by the key station and the local stations in broadcasting a data broadcast program. This enables any local station to broadcast a data broadcast program using the same bandwidth as the key station, and replacing part of the program with corresponding data in a manner unique to the local station, without changing the bandwidth.

In the above-described data replacement output apparatus, the determining unit may include: a judging sub-unit operable to, each time a unit of data is received, judge whether the received unit of data constitutes the replacement object data; and a comparing sub-unit operable to compare the total number of units of data constituting the replacement object data that have been received during the time period with the total number of units of data constituting the replacement data that have been output during the time period, wherein

the determining unit determines to perform the sequential output of data if it is found as a result of the comparison by the comparing sub-unit that the total number of units of data constituting the replacement data that have been output during the time period is no larger than the total number of units of data constituting the replacement object data that have been received during the time period.

With the above-described construction, if the number of units of data constituting the output replacement data surpasses the number of units of data constituting the input replacement object data, the replacement data is prohibited from being output. Then, the non-replacement-object data is kept to be output until the number of units of data constituting the output replacement data is no larger than the number of units of data constituting the input replacement object data. This enables the non-replacement-object data to be output without delay.

In the above-described data replacement output apparatus, the data output unit may include a storage sub-unit operable to store the non-replacement-object data, and the data output unit reads a unit of data constituting the non-replacement-object data from the storage sub-unit and outputs the read unit of data each time a unit of data constituting the non-replacement-object data is received while the sequential output of data is not performed, and if the determining unit determines not to perform the sequential output of data, reads a unit of data constituting the non-replacement-object data from the storage sub-unit and outputs the read unit of data each time a unit of data constituting the data stream is received.

With the above-described construction, the non-replacement-object data is obtained and stored in advance. This makes it possible to, if a unit of data constituting the non-replacement-object data is required, copy a unit of data constituting the stored non-replacement-object data and output the copied unit of data, without obtaining and outputting the unit of data each time it is required.

In the above-described data replacement output apparatus, the determining unit may include: a judging sub-unit operable to, each time a unit of data is received, judge whether the received unit of data constitutes the replacement object data; a calculating sub-unit operable to calculate a replacement excess count value by subtracting (i) the total number of units of data constituting the replacement data that have been output during the time period from (ii) the total number of units of data constituting the replacement object data that have been received during the time period; and a count value judging sub-unit operable to judge whether the replacement excess count value is smaller than the predetermined number as in the predetermined number of units of data constituting the replacement data that are output sequentially, and the determining unit determines to perform the sequential output of data if the count value judging sub-unit judges that the replacement excess count value is no smaller than the predetermined number.

With the above-described construction, the number of units of data constituting the output replacement data does not surpass the number of units of data constituting the input replacement object data excessively. This enables the non-replacement-object data to be output without delay, enabling the users to obtain the non-replacement-object data without delay via the receiving apparatuses.

In the above-described data replacement output apparatus, the determining unit may include: a judging sub-unit operable to, each time a unit of data is received, judge whether the received unit of data constitutes the replacement object data; a calculating sub-unit operable to calculate a replacement excess count value by subtracting (i) the total number of units of data constituting the replacement data that have been output during the time period from (ii) the total number of units of data constituting the replacement object data that have been received during the time period; and a count value judging sub-unit operable to judge whether the replacement excess count value is no smaller than half of the predetermined number as in the predetermined number of units of data constituting the replacement data that are output sequentially, and the determining unit determines to perform the sequential output of data if the count value judging sub-unit judges that the replacement excess count value is no smaller than half of the predetermined number.

With the above-described construction, it is possible to output more units of data constituting the replacement data than units of data constituting the replacement object data being input. This enables the replacement data to be output at a higher speed than the speed at which the replacement object data is input, enabling the users to obtain the replacement data speedily via the receiving apparatuses.

In the above-described data replacement output apparatus, the data stream may include a plurality of types of replacement object data, the data output unit includes a replacement data storage sub-unit operable to store a plurality of types of replacement data that respectively correspond to the plurality of types of replacement object data, and the determining unit determines whether to perform the sequential output of a predetermined number of units of data constituting any of the plurality of types of replacement data, based on a result of comparison between each pair of (i) a total number of units of data constituting one of the plurality of types of replacement object data that have been received during the time period and (ii) a total number of units of data constituting one of the plurality of types of replacement data, which corresponds to the type of replacement object data in (i), that have been output during the time period.

Also, in the above-described data replacement output apparatus, the data stream may include a plurality of types of replacement object data, the data output unit includes a post-replacement data storage sub-unit operable to store a plurality of types of replacement data that respectively correspond to the plurality of types of replacement object data, and the determining unit determines whether to perform the sequential output of a predetermined number of units of data constituting any of the plurality of types of replacement data, based on a result of comparison between (i) a total number of units of data constituting the plurality of types of replacement object data that have been received during the time period and (ii) a total number of units of data constituting the plurality of types of replacement data that have been output during the time period.

With the above-described construction, the data replacement output apparatus replaces, for each of the plurality of types of input data, part of received data with corresponding data and outputs data with the replacement, while inputting and outputting data at the same speed. This enables any local station to broadcast a data broadcast program using the same bandwidth as the key station, and replacing part of the data broadcast program with corresponding data in a manner unique to the local station, without changing the bandwidth.

In the above-described data replacement output apparatus, the determining unit may calculate the replacement excess count value for each pair of a type of replacement object data and a corresponding type of replacement data, and if one or more replacement excess count values calculated by the determining unit are smaller than “0”, the determining unit selects a type of replacement data among one or more types of replacement data corresponding to the one or more replacement excess count values that are smaller than “0”, based on a predetermined criterion, and determines to perform the sequential output of a predetermined number of units of data constituting the selected type of replacement data.

With the above-described construction, if the number of units of data constituting any type of input replacement object data surpasses the number of units of data constituting the corresponding type of output replacement data, the units of data constituting the corresponding type of output replacement data are output. This makes it possible to control the number of units of data constituting the replacement data not to be output excessively for each type of replacement data with reference to the number of units of data constituting the corresponding type of input replacement object data.

In the above-described data replacement output apparatus, the determining unit may select a type of replacement data that corresponds to, the smallest value among the one or more replacement excess count values, and determines to perform the sequential output of a predetermined number of units of data constituting the selected type of replacement data.

The above-described construction prevents the number of units of data constituting any type of output replacement data from increasing or decreasing excessively, since a type of replacement data that corresponds to the smallest value of replacement excess count is output with preference.

In the above-described data replacement output apparatus, different priority levels may be respectively assigned to the plurality of types of replacement data, and the determining unit selects a type of replacement data to which the highest priority level has been assigned among one or more types of replacement data that correspond to the one or more replacement excess count values, and determines to perform the sequential output of a predetermined number of units of data constituting the selected type of replacement data.

In the above-described data replacement output apparatus, a type of replacement data may be pre-selected from the plurality of types of replacement data, and if a replacement excess count value for the pre-selected type of replacement data is smaller than “0”, the determining unit selects the pre-selected type of replacement data, and if the replacement excess count value for the pre-selected type of replacement data is no smaller than “0”, the determining unit selects a type of replacement data that corresponds to the smallest value among the one or more replacement excess count values, and determines to perform the sequential output of a predetermined number of units of data constituting the selected type of replacement data.

The above-described construction prevents an important type of replacement data from being transmitted with delay since a type of replacement data with the highest priority level is output first.

In the above-described data replacement output apparatus, different priority levels may be respectively assigned to the plurality of types of replacement data and the non-replacement-object data, the determining unit calculates the replacement excess count value for each pair of a type of replacement object data and a corresponding type of replacement data, and if one or more replacement excess count values calculated by the determining unit are smaller than “0”, and if any priority level assigned to a type of replacement data corresponding to a replacement excess count value smaller than “0” is no smaller than a priority level assigned to the non-replacement-object data, the determining unit determines to perform the sequential output of a predetermined number of units of data constituting any type of replacement data corresponding to any of replacement excess count values smaller than “0”.

The above-described construction prevents an important type of non-replacement-object data from being transmitted with delay since a type of non-replacement-object data with the highest priority level is output first.

The above object can also be achieved by a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data stream contains a sequence of M units of data constituting the replacement object data, the replacement data is composed of replacement-purpose data and dummy data, the data replacement output apparatus comprising: a replacement judging unit operable to judge whether a received unit of data belongs to the sequence of M units of data constituting the replacement object data or the non-replacement-object data; and a data output unit operable to, if the replacement judging unit judges that the received unit of data belongs to the sequence of M units of data constituting the replacement object data, sequentially output N units of data constituting the replacement-purpose data and (M−N) units of data constituting the dummy data each time the sequence of M units of data is received, where M≧N, and N is an integer no smaller than “1”, and operable to, if the replacement judging unit judges that the received unit of data belongs to the non-replacement-object data, output a unit of data constituting the non-replacement-object data each time a unit of data constituting the non-replacement-object data is received.

The above object can also be achieved by a data replacement output method for use in a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data stream contains a sequence of M units of data constituting the replacement object data, the replacement data is composed of replacement-purpose data and dummy data, the data replacement output method comprising: a replacement judging step for judging whether a received unit of data belongs to the sequence of M units of data constituting the replacement object data or the non-replacement-object data; and a data output step for, if the replacement judging step judges that the received unit of data belongs to the sequence of M units of data constituting the replacement object data, sequentially outputting N units of data constituting the replacement-purpose data and (M−N) units of data constituting the dummy data each time the sequence of M units of data is received, where M≧N, and N is an integer no smaller than “1”, and if the replacement judging step judges that the received unit of data belongs to the non-replacement-object data, outputting a unit of data constituting the non-replacement-object data each time a unit of data constituting the non-replacement-object data is received.

The above object can also be achieved by a data replacement output control program for use in a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data stream contains a sequence of M units of data constituting the replacement object data, the replacement data is composed of replacement-purpose data and dummy data, the data replacement output control program comprising: a replacement judging step for judging whether a received unit of data belongs to the sequence of M units of data constituting the replacement object data or the non-replacement-object data; and a data output step for, if the replacement judging step judges that the received unit of data belongs to the sequence of M units of data constituting the replacement object data, sequentially outputting N units of data constituting the replacement-purpose data and (M−N) units of data constituting the dummy data each time the sequence of M units of data is received, where M≧N, and N is an integer no smaller than “1”, and if the replacement judging step judges that the received unit of data belongs to the non-replacement-object data, outputting a unit of data constituting the non-replacement-object data each time a unit of data constituting the non-replacement-object data is received.

The above object can also be achieved by a computer-readable recording medium recording therein a data replacement output control program for use in a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data stream contains a sequence of M units of data constituting the replacement object data, the replacement data is composed of replacement-purpose data and dummy data, the data replacement output control program comprising: a replacement judging step for judging whether a received unit of data belongs to the sequence of M units of data constituting the replacement object data or the non-replacement-object data; and a data output step for, if the replacement judging step judges that the received unit of data belongs to the sequence of M units of data constituting the replacement object data, sequentially outputting N units of data constituting the replacement-purpose data and (M−N) units of data constituting the dummy data each time the sequence of M units of data is received, where M≧N, and N is an integer no smaller than “1”, and if the replacement judging step judges that the received unit of data belongs to the non-replacement-object data, outputting a unit of data constituting the non-replacement-object data each time a unit of data constituting the non-replacement-object data is received.

With the above-described construction, if the number of units of data constituting the replacement-purpose data to be output is not sufficient with reference to the number of units of data constituting the corresponding replacement object data having been input due to the difference between the replacement object data and the replacement-purpose data in data size, as much units of dummy data as are required are output to fill in the shortage of the replacement-purpose data, keeping data being input and output at the same speed.

The above object can also be achieved by a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data stream contains a sequence of a plurality of units of data constituting the replacement object data, the replacement data is composed of replacement-purpose data and dummy data, the data replacement output apparatus comprising: a replacement judging unit operable to judge whether a received unit of data belongs to the sequence of the plurality of units of data constituting the replacement object data or the non-replacement-object data; a detecting unit operable to detect a number of units of data contained in the sequence that constitutes the replacement object data if the replacement judging unit judges that the received unit of data belongs to the sequence of the plurality of units of data constituting the replacement object data; a judging unit operable to judge whether the number of units of data detected by the detecting unit is smaller than N, where N is an integer no smaller than “1”; and a data output unit operable to, if the judging unit judges that the number of units of data detected by the detecting unit is smaller than N, sequentially output as much units of data constituting the dummy data as the number of units of data detected by the detecting unit each time the sequence of the plurality of units of data is received, and operable to, if the judging unit judges that the number of units of data detected by the detecting unit is larger than N, sequentially output (i) N units of data constituting the replacement-purpose data and (ii) each time the sequence of the plurality of units of data is received, as much units of data constituting the dummy data as a difference between N and the number of units of data detected by the detecting unit, and operable to, if the replacement judging unit judges that the received unit of data belongs to the non-replacement-object data, output a unit of data constituting the non-replacement-object data each time a unit of data constituting the non-replacement-object data is received.

The above object can also be achieved by a data replacement output method for use in a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data stream contains a sequence of a plurality of units of data constituting the replacement object data, the replacement data is composed of replacement-purpose data and dummy data, the data replacement output method comprising: a replacement judging step for judging whether a received unit of data belongs to the sequence of the plurality of units of data constituting the replacement object data or the non-replacement-object data; a detecting step for detecting a number of units of data contained in the sequence that constitutes the replacement object data if the replacement judging step judges that the received unit of data belongs to the sequence of the plurality of units of data constituting the replacement object data; a judging step for judging whether the number of units of data detected in the detecting step is smaller than N, where N is an integer no smaller than “1”; and a data output step for, if the judging step judges that the number of units of data detected in the detecting step is smaller than N, sequentially outputting as much units of data constituting the dummy data as the number of units of data detected in the detecting step each time the sequence of the plurality of units of data is received, and if the judging step judges that the number of units of data detected in the detecting step is larger than N, sequentially outputting (i) N units of data constituting the replacement-purpose data and (ii) each time the sequence of the plurality of units of data is received, as much units of data constituting the dummy data as a difference between N and the number of units of data detected in the detecting step, and if the replacement judging step judges that the received unit of data belongs to the non-replacement-object data, outputting a unit of data constituting the non-replacement-object data each time a unit of data constituting the non-replacement-object data is received.

The above object can also be achieved by a data replacement output control program for use in a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data stream contains a sequence of a plurality of units of data constituting the replacement object data, the replacement data is composed of replacement-purpose data and dummy data, the data replacement output control program comprising: a replacement judging step for judging whether a received unit of data belongs to the sequence of the plurality of units of data constituting the replacement object data or the non-replacement-object data; a detecting step for detecting a number of units of data contained in the sequence that constitutes the replacement object data if the replacement judging step judges that the received unit of data belongs to the sequence of the plurality of units of data constituting the replacement object data; a judging step for judging whether the number of units of data detected in the detecting step is smaller than N, where N is an integer no smaller than “1”; and a data output step for, if the judging unit judges that the number of units of data detected in the detecting step is smaller than N, sequentially outputting as much units of data constituting the dummy data as the number of units of data detected in the detecting step each time the sequence of the plurality of units of data is received, and if the judging step judges that the number of units of data detected in the detecting step is larger than N, sequentially outputting (i) N units of data constituting the replacement-purpose data and (ii) each time the sequence of the plurality of units of data is received, as much units of data constituting the dummy data as a difference between N and the number of units of data detected in the detecting step, and if the replacement judging step judges that the received unit of data belongs to the non-replacement-object data, outputting a unit of data constituting the non-replacement-object data each time a unit of data constituting the non-replacement-object data is received.

The above object can also be achieved by a computer-readable recording medium recording therein a data replacement output control program for use in a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data stream contains a sequence of a plurality of units of data constituting the replacement object data, the replacement data is composed of replacement-purpose data and dummy data, the data replacement output control program comprising: a replacement judging step for judging whether a received unit of data belongs to the sequence of the plurality of units of data constituting the replacement object data or the non-replacement-object data; a detecting step for detecting a number of units of data contained in the sequence that constitutes the replacement object data if the replacement judging step judges that the received unit of data belongs to the sequence of the plurality of units of data constituting the replacement object data; a judging step for judging whether the number of units of data detected in the detecting step is smaller than N, where N is an integer no smaller than “1”; and a data output step for, if the judging unit judges that the number of units of data detected in the detecting step is smaller than N, sequentially outputting as much units of data constituting the dummy data as the number of units of data detected in the detecting step each time the sequence of the plurality of units of data is received, and if the judging step judges that the number of units of data detected in the detecting step is larger than N, sequentially outputting (i) N units of data constituting the replacement-purpose data and (ii) each time the sequence of the plurality of units of data is received, as much units of data constituting the dummy data as a difference between N and the number of units of data detected in the detecting step, and if the replacement judging step judges that the received unit of data belongs to the non-replacement-object data, outputting a unit of data constituting the non-replacement-object data each time a unit of data constituting the non-replacement-object data is received.

With the above-described construction, if the replacement object data is smaller than the corresponding replacement-purpose data in data size, as much units of dummy data as the number of units of data constituting the replacement object data having been input are output, keeping data being input and output at the same speed.

### BRIEF DESCRIPTION OF THE DRAWINGS

FIG. 1 is a functional block diagram showing the construction of a data replacement output apparatus 10 in Embodiment 1 of the present invention.

FIG. 2 shows a data structure of the material data TS packet stream received by the input data reception unit 100.

FIG. 3 shows the relationships between the TS packet, section, and module.

FIG. 4 shows an example of the TS packets contained in a TS packet stream (input TS packet stream 41) of material data input into the data replacement output apparatus 10, and an example of the TS packets contained in a TS packet stream (output TS packet stream 42) output from the data replacement output apparatus 10, the output TS packet stream 42 containing the post-replacement packets replacing the replacement object packets in the input TS packet stream 41.

FIG. 5 shows an example of a post-replacement module 50 that is composed of 10 sections from a section identified by block number=0 to a section identified by block number=9.

FIGS. 6A and 6B are a flowchart showing the procedures of the replacement output control process performed by the data replacement output apparatus 10.

FIG. 7 shows an example of a post-replacement module 70 that is identified as “module ID=3” and has the same data structure as the post-replacement module 50.

FIG. 8 is a functional block diagram showing the construction of the data replacement output apparatus 20.

FIG. 9 shows a replacement object module 90 composed of replacement object packets shown in FIG. 10.

FIG. 10 shows examples of the TS packets contained in a TS packet stream (input TS packet stream 51) input into the data replacement output apparatus 20, and examples of the TS packets contained in a TS packet stream (output TS packet stream 52) output from the data replacement output apparatus 20, the output TS packet stream 52 containing the post-replacement packets or null packets replacing the replacement object packets in the input TS packet stream 51.

FIG. 11 shows a post-replacement module 110 composed of post-replacement packets shown in FIG. 10.

FIG. 12 is a flowchart showing the procedures of the replacement output control process performed by the data replacement output apparatus 20.

FIG. 13 is a flowchart showing the procedures of the replacement output control process performed by the data replacement output apparatus 30.

FIG. 14 shows examples of the TS packets contained in a TS packet stream (input TS packet stream 61) input into the data replacement output apparatus 30, and examples of the TS packets contained in a TS packet stream (output TS packet stream 62) output from the data replacement output apparatus 30, the output TS packet stream 62 containing the post-replacement packets or null packets replacing the replacement object packets in the input TS packet stream 61.

FIG. 15 is a flowchart showing the procedures of the replacement output control process performed by the data replacement output apparatus 40.

FIG. 16 shows examples of the TS packets contained in a TS packet stream (input TS packet stream 71) input into the data replacement output apparatus 40, and examples of the TS packets contained in a TS packet stream (output TS packet stream 72) output from the data replacement output apparatus 40, the output TS packet stream 72 containing a section that contains three post-replacement packets.

FIGS. 17A and 17B are a flowchart showing the procedures of the replacement output control process performed by the data replacement output apparatus 50.

FIG. 18 is a functional block diagram showing the construction of the data replacement output apparatus 30.

FIG. 19 is a functional block diagram showing the construction of the data replacement output apparatus 40.

FIG. 20 is a functional block diagram showing the construction of the data replacement output apparatus 50.

FIGS. 21A and 21B are a flowchart showing the procedures of Modification (1) of the replacement output control process shown in FIGS. 17A and 17B performed by the data replacement output apparatus 50.

FIGS. 22A and 22B are a flowchart showing the procedures of Modification (3) of the replacement output control process shown in FIGS. 17A and 17B performed by the data replacement output apparatus 50.

### BEST MODE FOR CARRYING OUT THE INVENTION

### Embodiment 1

Construction

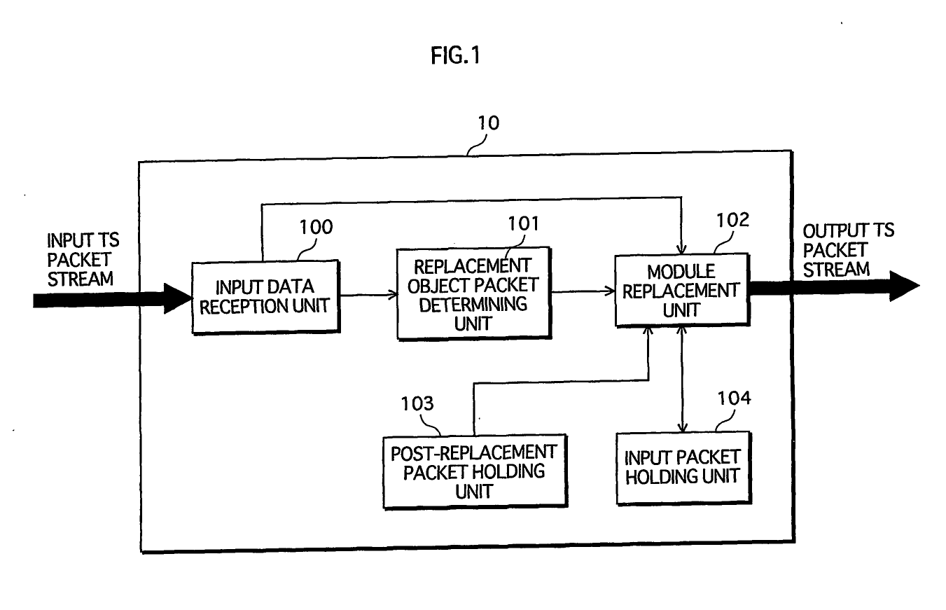

FIG. 1 is a functional block diagram showing the construction of a data replacement output apparatus 10 in Embodiment 1 of the present invention. As shown in FIG. 1, the data replacement output apparatus 10 is composed of an input data reception unit 100, a replacement object packet determining unit 101, a module replacement unit 102, a post-replacement packet holding unit 103, and an input packet holding unit 104.

The data replacement output apparatus 10 is composed of a CPU, ROM, RAM, hard disk, decoder, filter or the like as hardware, where a computer program is stored in the ROM or the hard disk, and each function of the data replacement output apparatus 10 is achieved as a result of the CPU operation in accordance with the computer program.

The input data reception unit 100 receives TS packet streams that contain material data and transmitted from outside by the DSM-CC data carousel transmission method, and outputs the received TS packet streams to the replacement object packet determining unit 101 and the module replacement unit 102.

Each TS packet stream is a sequence of data packets (hereinafter referred to as TS packets) having a fixed length of 188 octets. One TS packet stream is composed of a set of TS packets that contain video data and audio data constituting a digital broadcast program, and also contain material data constituting a data broadcast program. Also, necessary information is attached to each TS packet.

The TS packet stream is defined in the international standards: ISO/IEC 13818-1 “Information technology—Generic coding of moving pictures and associated audio information: Systems”; and ISO/IEC 13818-6 “Information technology—Generic coding of moving pictures and associated audio information: Part 6 Extensions for DSM-CC”. The TS packet stream is typically used for transmitting multiplexed data of video, audio and the like in digital broadcasting.

In the DSM-CC data carousel transmission method, the minimum unit of data transmission is the TS packet. A set of one or more TS packets constitutes a unit called “section”.

Each section contains 1 to 23 TS packets. A set of sections constitutes a module that is the minimum meaningful unit. Each module contains 1 to 255 sections.

The TS packet (hereinafter referred to as “start packet”) at the start of a section contains a “module ID”, “section number”, “block number”, and “section length”.

The module ID is an identifier of the module that contains the present section containing the start packet.

The block number is an identifier of the position of the present section in the sequence of sections constituting a module.

The section number is an identifier of the number of sections that constitute the module that contains the present section.

It should be noted here that in reality, the start packet contains “last section number” instead of “section number”, where the last section number shows the block number of the last section in the module that contains the present section. However, in the following description, “section number” is used for the sake of convenience (more specifically, the section number is identical to a value obtained by adding “1” to the last section number). The functions of the data replacement output apparatuses explained in the present embodiment and Embodiments 2-5 are therefore achieved even if “last section number” is used instead of “section number”.

The section length is an identifier of the data size of the present section.

Here, since each TS packet has a fixed length as described earlier, the data size of each section can be correlated with the number of TS packets contained in the section. Accordingly, in the following description, the data size of each section is indicated by “pnum” which represents the number of TS packets contained in the section, instead of the “section length”.

The replacement object packet determining unit 101 refers to the module ID contained in each start packet in a TS packet stream received by the input data reception unit 100, and judges for each TS packet in the received TS packet stream whether the TS packet is included in the data to be replaced (replacement object data), and notifies the module replacement unit 102 of the judgment result. Note that hereinafter, the TS packet that has been judged by the replacement object packet determining unit 101 that it is included in the replacement object data is referred to as “replacement object packet”).

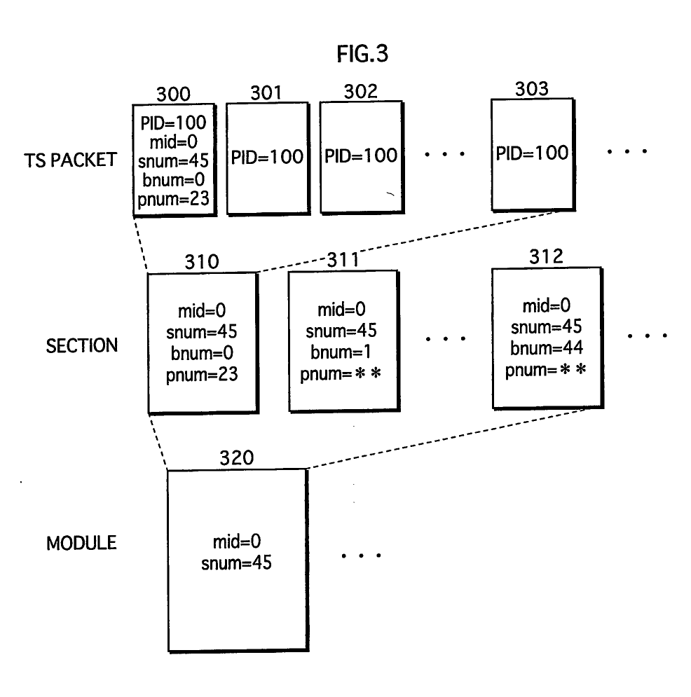

FIG. 3 shows the relationships between the TS packet, section, and module.

As shown in FIG. 3, a section 310 is composed of 23 TS packets: TS packet 300 to TS packet 303.

“PID” contained in each TS packet is an identifier of a data type (for example, video data, audio data, material data, or a type material data).

The designation “mid” is an abbreviation of “module ID”. The designation “snum” is an abbreviation of “section number”. The designation “bnum” is an abbreviation of “block number”.

The start packet (TS packet 300) of the section 310 contains “PID=100”, “mid=0”, “snum=45”, “bnum=0”, and “pnum=23”. The notation “mid=0” indicates that the module containing the present section is identified as “0”. The notation “snum=45” indicates that the module is composed of 45 sections. The notation “bnum=0” indicates that the present section is identified as “section 0”, that is, the first section in the module. The notation “pnum=23” indicates that the present section is composed of 23 TS packets.

Also, as shown in FIG. 3, the module 320 is composed of 45 sections: section 310 to section 312.

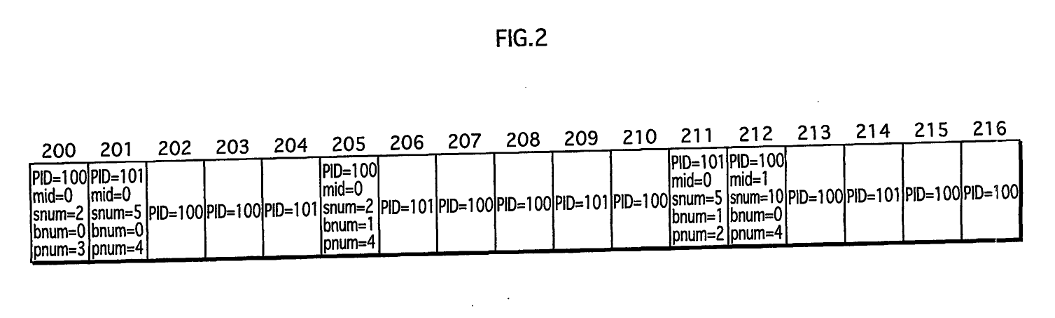

FIG. 2 shows a data structure of the material data TS packet stream received by the input data reception unit 100. In FIG. 2, boxes 200 to 216 respectively represent TS packets constituting the TS packet stream. In FIG. 2, the smaller the box number is, the earlier received the TS packet represented by the box number is. That is to say, in FIG. 2, the TS packet 200 has been received the earliest, and the TS packet 216 has been received most recently.

Each start packet of each section contains the values of “PID”, “mid”, “snum”, “bnum”, and “pnum”.

In the example shown in FIG. 2, the start packet 200 contains “PID=100”, “mid=0”, “snum=2”, “bnum=0”, and “pnum=3”. These values of the identifiers indicate that the section having the start packet 200 is contained in the module “0”, that the module is composed of two sections, that the present section is “section 0”, namely, the first section in the module, and that the present section is composed of three TS packets. What these identifiers indicate are recognized by the replacement object packet determining unit 101.

The other start packets shown in FIG. 2, namely, packets 201, 205, 211, and 212 similarly contain the identifiers “PID”, “mid”, “snum”, “bnum”, and “pnum”. Of these, identifiers “mid”, “snum”, “bnum”, and “pnum” provides information of identification of the module containing the present section, the number of sections constituting the module, the position of the present section in the sequence of sections constituting the module, and the number of TS packets contained in the present section. Hereinafter the information provided by the identifiers “mid”, “snum”, “bnum”, and “pnum” is referred to as “section information”.

The TS packets 202-204, 206-210, and 213-216, namely, the packets other than the start packets contain only PIDs. This is because the section information can be obtained from the start packets having the same PIDs as the TS packets. For example, the section information of the TS packets 202 and 203 is obtained from the start packet 200, and the section information of the TS packets 204, 206, and 209 is obtained from the start packet 201.

The section information must be provided each time sections change in the stream. For example, in the example shown in FIG. 2, the first section (identified as bnum=0) of the module “0” of the material data identified as PID=101 starts with the start packet 201 and ends with the TS packet 204. As a result, the start packet of the section that follows this section is required to contain the section information. In FIG. 2, this next section is identified as bnum=1 of the module “0” of the data identified as PID=100, and the start packet of this section is the TS packet 205. Further, the next section is identified as bnum=1 of the module “0” of the material data identified as PID=101, and the start packet of this section is the TS packet 211. Further, the next section is identified as bnum=0 of the module “1” of the data identified as PID=100, and the start packet of this section is the TS packet 212.

The MPEG2 standard defines that the transmitted stream should not include a mixture of TS packets that have the same PID and belong to different sections. That is to say, in transmission of TS packets having the same PID, TS packets belonging to the next section cannot not be transmitted until all TS packets belonging to the current section have been transmitted.

This is because if a TS packet stream in which such TS packets of different sections and the same PID are arranged in a mixed state is received, the number of TS packets indicated by the section information may not match the number of actually received TS packets. For example, if the TS packet stream shown in FIG. 2 were received and if the TS packet 205 were inserted between the TS packets 202 and 203 in the received TS packet stream, then although the section information of the section identified as “bnum=0” indicates that the number of TS packets contained in the section is “3” as identified by “pnum=3”, the input data reception unit 100 would recognize that the number of actually received TS packets in the section is “2”.

Due to the above-described limitation defined in the MPEG2 standard, in the following description, it is presumed that the TS packets are output on a section by section basis.

The post-replacement packet holding unit 103 holds post-replacement modules.

It should be noted here that the “post-replacement module” refers to a module to be output in replacement of a replacement object module that contains a plurality of replacement object packets. Each post-replacement module is composed of a plurality of TS packets. Hereinafter, the TS packets constituting the post-replacement module are referred to as post-replacement packets.

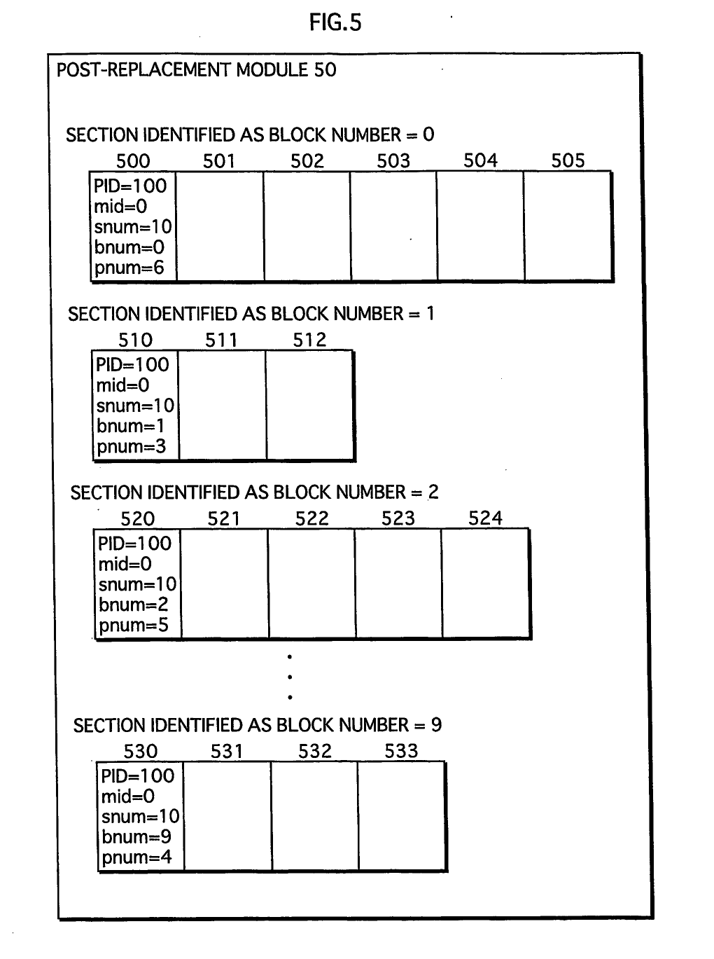

FIG. 5 shows an example of the post-replacement module. As shown in FIG. 5, a post-replacement module 50 is composed of 10 sections from a section identified by block number=0 to a section identified by block number=9.

The input packet holding unit 104 holds non-replacement-object packets in a queue.

It should be noted here that the “non-replacement-object packets” are TS packets that have been judged by the replacement object packet determining unit 101 as not being the replacement object packets.

The module replacement unit 102 deletes the TS packets that have been judged by the replacement object packet determining unit 101 as the replacement object packets from the TS packet stream received by the input data reception unit 100, and stores the TS packets that have been judged by the replacement object packet determining unit 101 as the non-replacement-object packets into the input packet holding unit 104.

Also, in the replacement output control process which will be described later, the module replacement unit 102 selects either a non-replacement-object packet or a post replacement packet as a TS packet to be output, sequentially for each TS packet in the received TS packet stream, and outputs the selected TS packet at a bit rate that is the same as that at which the received TS packet stream was transmitted.

More specifically, each time a TS packet is input from outside, a TS packet that has been selected by the module replacement unit 102 is output.

With the above-described operation, the replacement object packets contained in the received TS packet stream are replaced with the post-replacement packets, and the TS packets after the replacement are output in sequence, where the TS packets are input and output at the same bit rate.

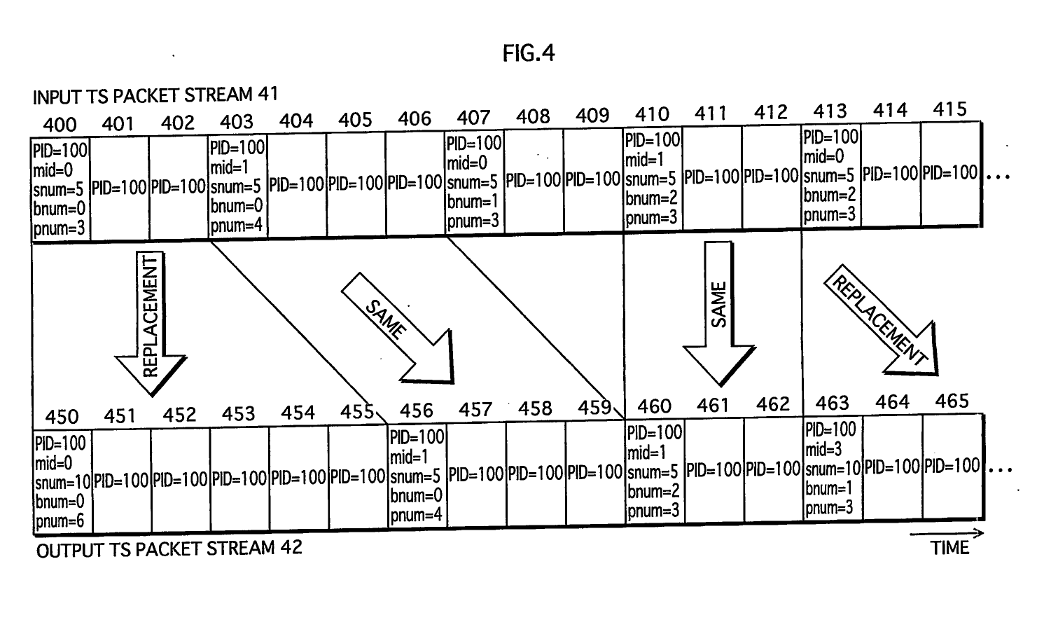

FIG. 4 shows an example of the TS packets contained in a TS packet stream (input TS packet stream 41) of material data input into the data replacement output apparatus 10, and an example of the TS packets contained in a TS packet stream (output TS packet stream 42) output from the data replacement output apparatus 10, the output TS packet stream 42 containing the post-replacement packets replacing the replacement object packets in the input TS packet stream 41.

In FIG. 4, boxes 400-415 represent TS packets contained in the input TS packet stream 41, and boxes 450-465 represent TS packets contained in the output TS packet stream 42.

Also, TS packets 400, 403, 407, 410, and 413 in the input TS packet stream 41 are start packets of the respective sections. Similarly, TS packets 450, 456, 460, and 463 in the output TS packet stream 42 are start packets of the respective sections.

TS packets 400-402, 407-409, and 413-415 which belong to a module identified as “mid=0” in the input TS packet stream 41 are replacement object packets. TS packets 450-455 and 463-465 in the output TS packet stream 42 are post-replacement packets inserted by the module replacement unit 102.

TS packets 403-406 and 410-412 in the input TS packet stream 41 are non-replacement-object packets, and therefore they are not replaced with other TS packets by the module replacement unit 102 but are included as they are in the output TS packet stream 42 as TS packets 456-459 and 460-462, respectively.

It should be noted here that in the example of the input TS packet stream 41 shown in FIG. 4, all the TS packets belong to the same type of data identified as PID=100, for the sake of convenience. However, the TS packets in the input TS packet stream 41 may belong to other types of data identified by other PID values.

Operation

1. Operation of Replacement Output Control Process in Embodiment 1

The following describes the replacement output control process performed by the data replacement output apparatus 10.

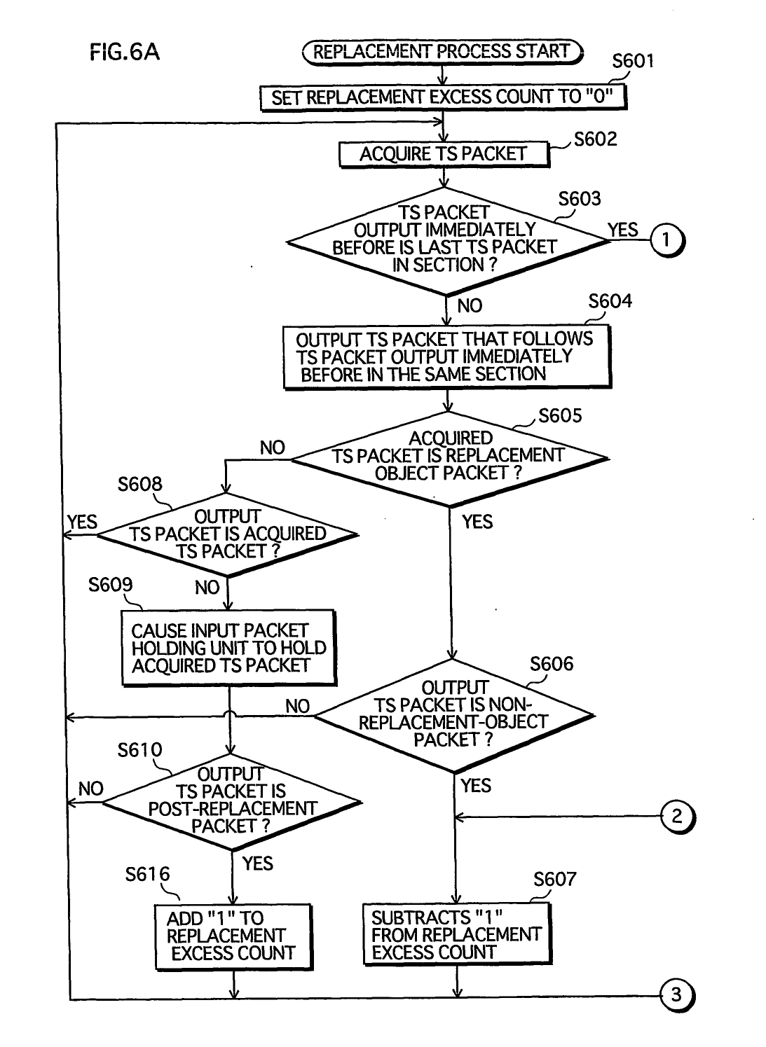

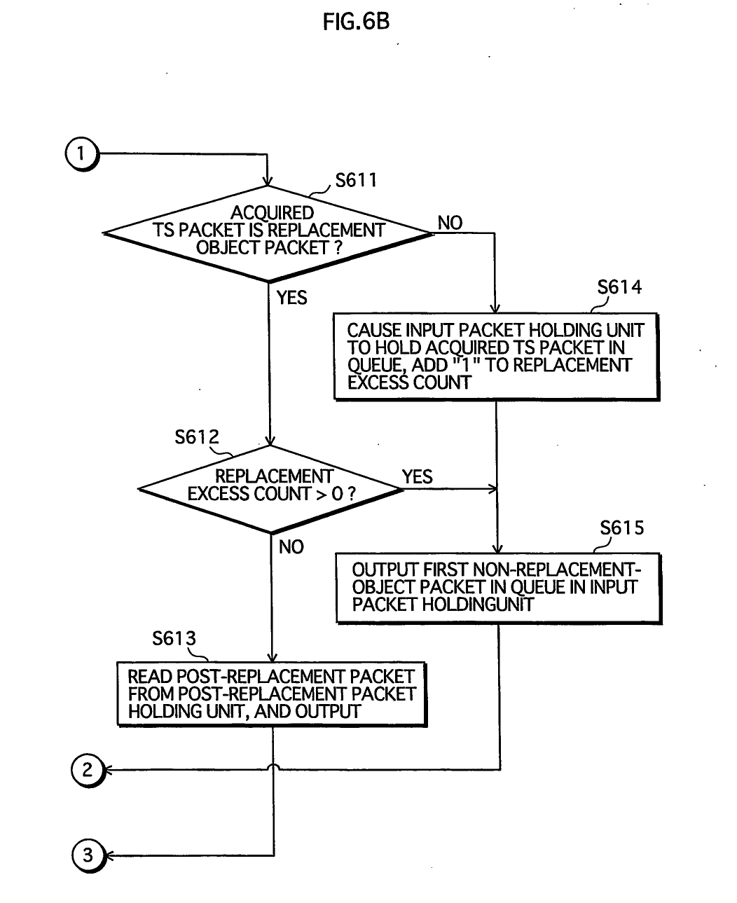

FIGS. 6A and 6B are a flowchart showing the procedures of the replacement output control process performed by the data replacement output apparatus 10. Now, the operation will be described with reference to FIGS. 6A and 6B.

After a computer program for executing the replacement output control process is activated, the module replacement unit 102 sets a replacement excess count to “0” (step S601).

The replacement excess count is a count that corresponds to a difference between the total number of post-replacement packets the module replacement unit 102 has output and the total number of the replacement object packets the module replacement unit 102 has received from the input data reception unit 100.

Following step S601, the module replacement unit 102 acquires a TS packet from the input data reception unit 100 (step S602), then judges whether the module replacement unit 102 has output any TS packet prior to this step, and if it has output any TS packet, and judges whether a TS packet having been output immediately before is the last TS packet in the section to which the TS packet output immediately before belongs (step S603).

The judgment in step S603 can be achieved, for example, in the following manner: both the post-replacement packet holding unit 103 and the input packet holding unit 104 have in advance an output packet management table that stores values of “PID”, “block number”, “pnum” of the packets the holding unit outputs, and a value of “the number of output packets” in correspondence with each value of “block number”, and each time either of the holding unit 103 or 104 outputs a TS packet to the module replacement unit 102, the holding unit increases the value of “the number of output packets” of the corresponding “block number” by one, and judges whether the increased value of “the number of output packets” matches the “pnum”.

In the above-described operation, each time it is judged that the increased value of “the number of output packets” matches the “pnum”, “the number of output packets” may be reset to “0” so that the same judgment process can be repeatedly performed on the TS packets that belong to the same PID and the same “block number”.

If the module replacement unit 102 judges in step S603 that it has not output any TS packet prior to this step, or that a TS packet having been output immediately before is the last TS packet in the section to which the TS packet output immediately before belongs (“Yes” in step S603), the module replacement unit 102 judges whether the acquired TS packet is a replacement object packet based on the notification of the judgment result sent from the replacement object packet determining unit 101 (step S611).

If the module replacement unit 102 judges in step S611 that the acquired TS packet is a replacement object packet (“Yes” in step S611), the module replacement unit 102 judges whether the replacement excess count is larger than “0” (step S612). If it judges in step S612 that the replacement excess count is larger than “0” (“Yes” in step S612), the module replacement unit 102 reads the first non-replacement-object packet among those in the queue from the input packet holding unit 104 and outputs the read packet (step S615), subtracts “1” from the replacement excess count (step S607), and returns to step S602.

If the module replacement unit 102 judges in step S612 that the replacement excess count is not larger than “0” (“No” in step S612), the module replacement unit 102 reads a post-replacement packet from the post-replacement packet holding unit 103 and outputs the read packet (step S613), and returns to step S602.

If the module replacement unit 102 judges in step S611 that the acquired TS packet is not a replacement object packet (“No” in step S611), the module replacement unit 102 causes the input packet holding unit 104 to hold the TS packet acquired in step S602 in the queue, adds “1” to the replacement excess count (step S614), and proceeds to step S615.

If the module replacement unit 102 judges in step S603 that it has output any TS packet prior to this step, and that a TS packet having been output immediately before is not the last TS packet in the section to which the TS packet output immediately before belongs (“No” in step S603), the module replacement unit 102 reads, from either the post-replacement packet holding unit 103 or the input packet holding unit 104, a TS packet that, in the same section, follows the TS packet having been output immediately before, and outputs the read TS packet (step S604). The module replacement unit 102 then judges whether the acquired TS packet is a replacement object packet based on the notification of the judgment result sent from the replacement object packet determining unit 101 (step S605).

If the module replacement unit 102 judges in step S605 that the acquired TS packet is not a replacement object packet (“No” in step S605), the module replacement unit 102 judges whether the TS packet output in step S604 is the acquired TS packet (step S608). If it judges that the output TS packet is not the acquired TS packet (“No” in step S608), the module replacement unit 102 causes the input packet holding unit 104 to hold the TS packet acquired in step S602 in the queue (step S609), and proceeds to step S610 in which the module replacement unit 102 judges whether the TS packet output in step S604 is a post-replacement packet based on whether the output TS packet was read from the post-replacement packet holding unit 103 (step S610). If the module replacement unit 102 judges in step S610 that the output TS packet is a post-replacement packet (“Yes” in step S610), the module replacement unit 102 adds “1” to the replacement excess count (step S616), and returns to step S602.

If the module replacement unit 102 judges in step S605 that the acquired TS packet is a replacement object packet (“Yes” in step S605), the module replacement unit 102 judges whether the TS packet output in step S604 is a non-replacement-object packet based on whether the output TS packet was read from the input packet holding unit 104 (step S606). If it judges that the output TS packet is a non-replacement-object packet (“Yes” in step S606), the module replacement unit 102 subtracts “1” from the replacement excess count (step S607), and returns to step S602.

If the module replacement unit 102 judges in step S606 that the output TS packet is not a non-replacement-object packet (“no” in step S606), the module replacement unit 102 returns to step S602. Also, if the module replacement unit 102 judges in step S608 that the TS packet output in step S604 is the acquired TS packet (“Yes” in step S608), the module replacement unit 102 returns to step S602. Also, if the module replacement unit 102 judges in step S610 that the output TS packet is not a post-replacement packet (“No” in step S610), the module replacement unit 102 returns to step S602.

2. Specific Example of Replacement Output Control Process in Embodiment 1

Now, the operation of the replacement output control process will be explained using the specific example shown in FIG. 4.

After a computer program for executing the replacement output control process is activated, the module replacement unit 102 sets a replacement excess count to “0” (step S601), then acquires TS packet 400, which is the first TS packet in the input TS packet stream shown in FIG. 4, from the input data reception unit 100 (step S602). In the next step S603, the module replacement unit 102 judges positively since it has not output any TS packet prior to this step (“Yes” in step S603), and therefore goes to step S611. In step S611, the module replacement unit 102 judges that the acquired TS packet is a replacement object packet based on the notification of the judgment result sent from the replacement object packet determining unit 101 (“Yes” in step S611), and goes to step S612 to judge whether the replacement excess count is larger than “0” (step S612).

At this point, the replacement excess count is “0”, and therefore the module replacement unit 102 judges that the replacement excess count is not larger than “0” (“No” in step S612), and goes to step S613. In step S613, the module replacement unit 102 reads a post-replacement packet (TS packet 500, which is the first TS packet in the section identified by block number=0 shown in FIG. 5) from the post-replacement packet holding unit 103 and outputs the read packet (step S613), and returns to step S602.

The TS packet 500 read in the above step is output as the TS packet 450 in the output TS packet stream 42 shown in FIG. 4.

In step S602 in the next round, the module replacement unit 102 acquires, from the input data reception unit 100, the TS packet 401 in the input TS packet stream 41 shown in FIG. 4 (step S602), and proceeds to step S603 to judges whether a TS packet having been output immediately before is the last TS packet in the section to which the TS packet output immediately before belongs (step S603). In step S603, the module replacement unit 102 judges negatively (“No” in step S603) since the TS packet 450 output immediately before is the TS packet 500 that is the first TS packet in the section identified by block number=0 shown in FIG. 5, and “pnum=6” in the section information indicates that the section contains five more TS packets, and proceeds to step S604. In step S604, the module replacement unit 102 reads, from the post-replacement packet holding unit 103, TS packet 501 that follows the TS packet 500 having been output immediately before in the section identified by block number=0 shown in FIG. 5, and outputs the read packet 501 as the TS packet 451 in the output TS packet stream 42 shown in FIG. 4 (step S604), and proceeds to step S605 to judge whether the acquired TS packet 401 is a replacement object packet based on the notification of the judgment result sent from the replacement object packet determining unit 101 (step S605).

In step S605, the module replacement unit 102 judges positively (“Yes” in step S605) since the acquired TS packet 401 has been notified as a replacement object packet (“Yes” in step S605), and goes to step S606 to judge whether the TS packet 451 output in step S604 is a non-replacement-object packet (step S606).

In step S606, the module replacement unit 102 judges negatively since the TS packet 451 is a replacement object packet (“No” in step S606), and returns to step S602.

In step S602 in the next round, the module replacement unit 102 acquires, from the input data reception unit 100, the TS packet 402 in the input TS packet stream 41 shown in FIG. 4 (step S602), goes through a similar process to the TS packet 401 in the previous round, and in step S604, reads TS packet 502 that follows the TS packet 501 in the section identified by block number=0 from the post-replacement packet holding unit 103, and outputs the read packet 502 as the TS packet 452 in the output TS packet stream 42 shown in FIG. 4 (step S604). Then, after going through a similar process to the TS packet 401 in following steps, the module replacement unit 102 returns to step S602.

In step S602 in the next round, the module replacement unit 102 acquires, from the input data reception unit 100, the TS packet 403 in the input TS packet stream 41 shown in FIG. 4 (step S602). In the following step S603, the module replacement unit 102 judges that the TS packet having been output immediately before is not the last TS packet in the section to which the TS packet output immediately before belongs (“No” in step S603) since the TS packet 452 having been output immediately before is the post-replacement packet 502 that is not the last TS packet in the section identified as “block number=0”. In the next step S604, the module replacement unit 102 reads, from the post-replacement packet holding unit 103, TS packet 503 that follows the TS packet 502 having been output immediately before in the section identified by block number=0 shown in FIG. 5, and outputs the read packet 503 as the TS packet 453 in the output TS packet stream 42 shown in FIG. 4 (step S604), and proceeds to step S605 to judge whether the acquired TS packet 403 is a replacement object packet based on the notification of the judgment result sent from the replacement object packet determining unit 101 (step S605).

In step S605, the module replacement unit 102 judges negatively (“No” in step S605) since the acquired TS packet 403 has been notified as not a replacement object packet, and goes to step S608 to judge whether the TS packet 453 output in step S604 is the acquired TS packet 403 (step S608).

In step S608, the module replacement unit 102 judges negatively since the output TS packet 453 is a post-replacement packet 503, not the acquired TS packet 403 (“No” in step S608), and proceeds to step S609.

In step S609, the module replacement unit 102 causes the input packet holding unit 104 to hold the TS packet 403 acquired in step S602 in the queue (step S609), and proceeds to step S610. In step S610, the module replacement unit 102 judges that the TS packet 453 output in step S604 is a post-replacement packet (“Yes” in step S610). The module replacement unit 102 then adds “1” to the replacement excess count (step S616), and returns to step S602.

In the following rounds, the module replacement unit 102 acquires, from the input data reception unit 100, the TS packets 404 and 405 in the input TS packet stream 41 shown in FIG. 4, respectively in step S602, goes through similar processes to the TS packet 403 in the previous round. That is, in step S604, the module replacement unit 102 reads TS packets 504 and 505 that follow the TS packet 503 in the section identified by block number=0 from the post-replacement packet holding unit 103, and outputs the read packets 504 and 505 as the TS packets 454 and 455 in the output TS packet stream 42 shown in FIG. 4 (step S604). Then after going through similar processes to the TS packet 403 in the previous round, the module replacement unit 102 causes the input packet holding unit 104 to hold the TS packets 404 and 405 in sequence acquired in step S602 in the queue (step S609), adds “1” to the replacement excess count each time in step S610, and returns to step S602. At this point in time, the input packet holding unit 104 holds TS packets 403, 404, and 405 in this order in the queue, and the replacement excess count is “3”.

In step S602 in the next round, the module replacement unit 102 acquires, from the input data reception unit 100, the TS packet 406 in the input TS packet stream 41 shown in FIG. 4 (step S602). In the following step S603, the module replacement unit 102 judges that the TS packet 455 having been output immediately before is the last TS packet in the section to which the TS packet output immediately before belongs (“Yes” in step S603) since the TS packet 455 having been output immediately before is the last post-replacement packet 505 in the section identified as “block number=0” shown in FIG. 5. In the next step S611, the module replacement unit 102 judges that the acquired TS packet is not a replacement object packet based on the notification of the judgment result sent from the replacement object packet determining unit 101 (“No” in step S611). In the next step S614, the module replacement unit 102 causes the input packet holding unit 104 to hold the TS packet 406 acquired in step S602 in the queue, adds “1” to the replacement excess count (step S614), and proceeds to step S615. In the next step S615, the module replacement unit 102 reads a non-replacement-object packet (TS packet 403 that is the first packet in the queue) from the input packet holding unit 104 and outputs the read packet 403 as the TS packet 456 in the output TS packet stream 42 (step S615), subtracts “1” from the replacement excess count (step S607), and returns to step S602. At this point in time, the input packet holding unit 104 holds TS packets 404, 405, and 406 in this order in the queue, and the replacement excess count is “3”.

In step S602 in the next round, the module replacement unit 102 acquires, from the input data reception unit 100, the TS packet 407 in the input TS packet stream 41 shown in FIG. 4 (step S602), and proceeds to step S603 to judges whether a TS packet having been output immediately before is the last TS packet in the section to which the TS packet output immediately before belongs (step S603). In step S603, the module replacement unit 102 judges negatively (“No” in step S603) since the TS packet 456 output immediately before is the TS packet 403 in the input TS packet stream 41 and is the start packet of the section identified as “block number=O” belonging to module identified as “module ID=1”, and the “pnum=4” in the section information indicates that the section includes three more TS packets, and proceeds to step S604. In step S604, the module replacement unit 102 reads, from the input packet holding unit 104, TS packet 404 that follows the TS packet 403 having been output immediately before, and outputs the read packet 404 as the TS packet 457 in the output TS packet stream 42 shown in FIG. 4 (step S604), and proceeds to step S605 to judge whether the acquired TS packet 407 is a replacement object packet based on the notification of the judgment result sent from the replacement object packet determining unit 101 (step S605).

In step S605, the module replacement unit 102 judges positively (“Yes” in step S605) since the acquired TS packet 407 has been notified as a replacement object packet (“Yes” in step S605), and goes to step S606 to judge whether the TS packet 457 output in step S604 is a non-replacement-object packet (step S606).

In step S606, the module replacement unit 102 judges positively since the TS packet 457 is a non-replacement-object packet (“Yes” in step S606). In the next step S607, the module replacement unit 102 subtracts “1” from the replacement excess count (step S607), and returns to step S602. At this point in time, the input packet holding unit 104 holds TS packets 405 and 406 in this order in the queue, and the replacement excess count is “2”.

In the following rounds, the module replacement unit 102 acquires, from the input data reception unit 100, the TS packets 408 and 409 in the input TS packet stream 41 shown in FIG. 4, respectively in step S602, goes through similar processes to the TS packet 407 in the previous round. That is, in step S604, the module replacement unit 102 reads TS packets 405 and 406 that follow the TS packet 404 from the input packet holding unit 104, and outputs the read packets 405 and 406 as the TS packets 458 and 459 in the output TS packet stream 42 shown in FIG. 4 (step S604). Then after subtracting “1” from the replacement excess count (step S607), the module replacement unit 102 returns to step S602.

At this point in time, the input packet holding unit 104 has output TS packets 405 and 406 and holds no TS packet in the queue, and the replacement excess count is “0”.

As described above, the progress in this operation example so far shows that even though an excess of three TS packets, namely, a difference between the replacement object packets (TS packets 400-402 in the input TS packet stream 41 shown in FIG. 40) and post-replacement packets (TS packets 453-455 in the output TS packet stream 42 shown in FIG. 4) was generated, the excess of three TS packets was eliminated by prohibiting the post-replacement packets that correspond to the replacement-object packets (TS packets 407-409 in the input TS packet stream 41 shown in FIG. 40) from being output. This shows the effectiveness of the present embodiment in adjusting the excess of TS packets.

In step S602 in the next round, the module replacement unit 102 acquires, from the input data reception unit 100, the TS packet 410 in the input TS packet stream 41 shown in FIG. 4 (step S602). In the following step S603, the module replacement unit 102 judges that the TS packet having been output immediately before is the last TS packet in the section to which the TS packet output immediately before belongs (“Yes” in step S603) since the TS packet 459 having been output immediately before is the TS packet 406 that is the last TS packet in the section identified by “block number=0” of the module identified by “module ID=1”. In the next step S611, the module replacement unit 102 judges that the acquired TS packet 410 is not a replacement object packet based on the notification of the judgment result sent from the replacement object packet determining unit 101 (“No” in step S611). In the next step S614, the module replacement unit 102 causes the input packet holding unit 104 to hold the TS packet 410 acquired in step S602 in the queue, adds “1” to the replacement excess count (step S614), and proceeds to step S615. In the next step S615, the module replacement unit 102 reads the TS packet 410 from the input packet holding unit 104, and outputs the read packet 410 as the TS packet 460 in the output TS packet stream 42 (step S615), subtracts “1” from the replacement excess count (step S607), and returns to step S602.

In step S602 in the next round, the module replacement unit 102 acquires, from the input data reception unit 100, the TS packet 411 in the input TS packet stream 41 shown in FIG. 4 (step S602). In the following step S603, the module replacement unit 102 judges that the TS packet having been output immediately before is not the last TS packet in the section to which the TS packet output immediately before belongs (“No” in step S603) since the TS packet 460 having been output immediately before is the TS packet 410 that is the first TS packet in the section identified by “block number=2” of the module identified by “module ID=1”, and the “pnum=3” in the section information indicates that the section includes two more TS packets, and proceeds to step S604. In step S604, since the TS packet 411 acquired in step S602 is the TS packet that follows the TS packet 410 that is the TS packet having been output immediately before, the module replacement unit 102 outputs the acquired TS packet 411 as the TS packet 461 in the output TS packet stream 42 shown in FIG. 4 (step S604), and proceeds to step S605 to judge whether the acquired TS packet 411 is a replacement object packet based on the notification of the judgment result sent from the replacement object packet determining unit 101 (step S605).

In step S605, the module replacement unit 102 judges negatively (“No” in step S605) since the acquired TS packet 411 is a non-replacement-object object packet, and goes to step S608 to judge whether the TS packet 461 output in step S604 is the acquired TS packet 411 (step S608).

In step S608, the module replacement unit 102 judges positively since the output TS packet 461 is the acquired TS packet 411 (“Yes” in step S608), and returns to step S602.

In the following rounds, the module replacement unit 102 acquires, from the input data reception unit 100, the TS packet 412 in the input TS packet stream 41 shown in FIG. 4 (step S602), goes through similar processes to the TS packet 411 in the previous round, and outputs the acquired TS packet 412 as the TS packet 462 in the output TS packet stream 42 shown in FIG. 4.

In the following rounds, the module replacement unit 102 acquires, from the input data reception unit 100, the TS packets 413-415 in the input TS packet stream 41 shown in FIG. 4, respectively in step S602, goes through similar processes to the TS packets 400-402 in the previous rounds, reads TS packets 510-512 shown in FIG. 5 from the post-replacement packet holding unit 103, and outputs the read packets 510-512 as the TS packets 463-465 in the output TS packet stream 42 shown in FIG. 4.

### Embodiment 2

A data replacement output apparatus 20 in Embodiment 2 is characterized in that even if a post-replacement module is smaller than a replacement object module in data size, the data replacement output apparatus 20 outputs the post-replacement module replacing the replacement object module at a bit rate that is the same as that at which the replacement object module was received.

Construction

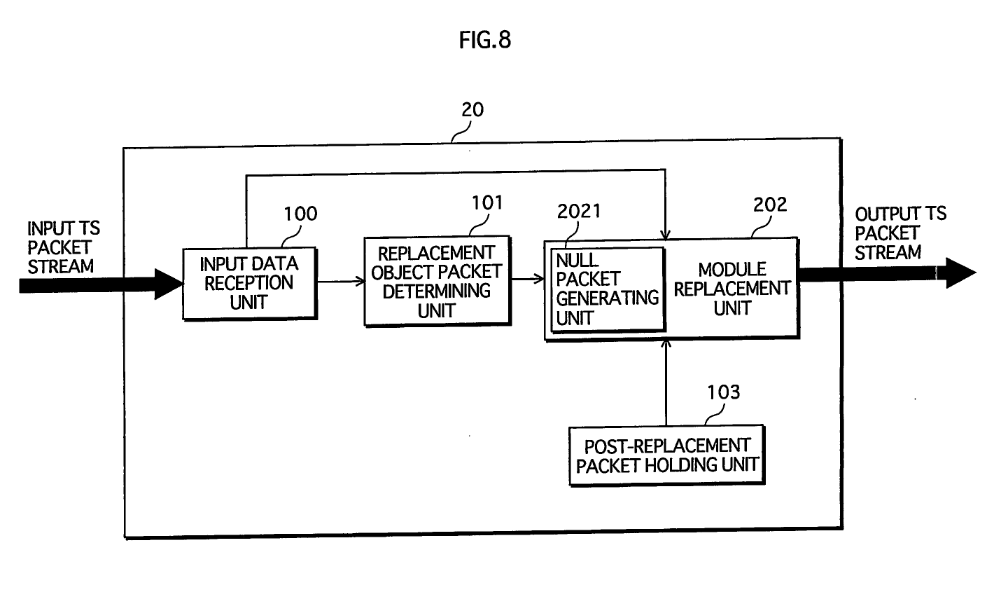

FIG. 8 is a functional block diagram showing the construction of the data replacement output apparatus 20. As shown in FIG. 8, the data replacement output apparatus 20 is composed of the input data reception unit 100, the replacement object packet determining unit 101, a module replacement unit 202, and the post-replacement packet holding unit 103.

In the following description, the components having already been explained in Embodiment 1 as those of the data replacement output apparatus 10 will be omitted, and mainly differences from Embodiment 1 will be explained.

The module replacement unit 202 receives TS packet streams from the input data reception unit 100, and among the TS packets contained in the received streams, deletes TS packets judged as replacement object packets by the replacement object packet determining unit 101, and outputs TS packets judged as non-replacement-object packets by the replacement object packet determining unit 101.

The module replacement unit 202 includes a null packet generating unit 2021 that generates null packets. The module replacement unit 202, in the replacement output control process which will be described later, selects one out of a non-replacement-object packet, a post replacement packet, and a null packet sequentially for each TS packet in the received TS packet stream, and outputs the selected TS packet at a bit rate that is the same as that at which the received TS packet stream was transmitted.

It should be noted here that the null packet is a dummy packet that has the same data size as the TS packet, and is used to supplement the shortage of the TS packets to be output.

Operation

1. Operation of Replacement Output Control Process in Embodiment 2

The following describes the replacement output control process performed by the data replacement output apparatus 20.

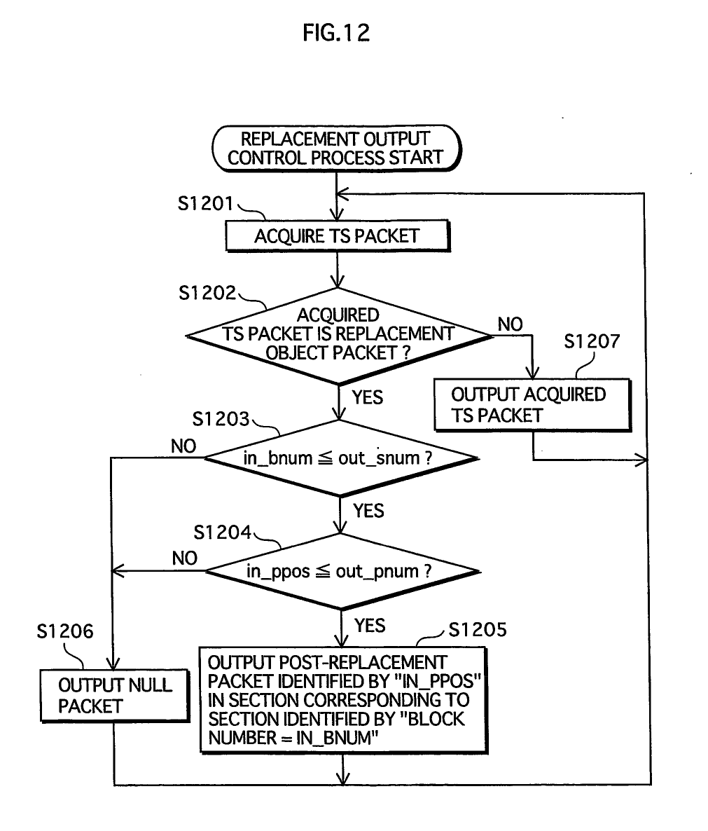

FIG. 12 is a flowchart showing the procedures of the replacement output control process performed by the data replacement output apparatus 20. Now, the operation will be described with reference to FIG. 12.

After a computer program for executing the replacement output control process is activated, the module replacement unit 202 acquires a TS packet from the input data reception unit 100 (step S1201), then judges whether the acquired TS packet is a replacement object packet based on the notification of the judgment result sent from the replacement object packet determining unit 101 (step S1202).

If the module replacement unit 202 judges that the acquired TS packet is a replacement object packet (“Yes” in step S1202), the module replacement unit 202 compares values between “in_bnum” and “out_snum” and judges whether “in_bnum” is no larger than “out_snum” (step S1203).

It should be noted here that “in_bnum” represents the “block number” of the section to which the present replacement object packet belongs, and that “out_snum” represents the “section number” of the post-replacement module that contains the present section.

If the module replacement unit 202 judges that “in_bnum” is no larger than “out_snum” (“Yes” in step S1203), the module replacement unit 202 further compares values between “in_ppos” and “out_pnum” and judges whether “in_ppos” is no larger than “out_pnum” (step S1204).

It should be noted here that “in_ppos” is an identifier of the position of the present replacement object packet in the sequence of TS packets constituting a section that is identified by the value of “in_bnum”, and “out_pnum” is an identifier of the number of TS packets contained in a section in the post-replacement module, the section corresponding to the section identified by the value of “in_bnum” (the two sections are identified by the same value of “block number”).

If the module replacement unit 202 judges that “in_ppos” is no larger than “out_pnum” (“Yes” in step S1204), the module replacement unit 202 outputs a post-replacement packet that is identified by “in_ppos” in a section in the post-replacement module, the section corresponding to the section identified by the value of “in_bnum” (the two sections are identified by the same value of “block number”) (step S1205), and returns to step S1201.

If the module replacement unit 202 judges that the acquired TS packet is not a replacement object packet (“No” in step S1202), the module replacement unit 202 outputs the acquired TS packet (step S1207), and returns to step S1201.

If the module replacement unit 202 judges that “in_bnum” is larger than “out_snum” (“No” in step S1203), the module replacement unit 202 outputs a null packet (step S1206), and returns to step S1201.

Also, if the module replacement unit 202 judges that “in_ppos” is larger than “out_pnum” (“No” in step S1204), the module replacement unit 202 outputs a null packet (step S1206), and returns to step S1201.

2. Specific Example of Replacement Output Control Process in Embodiment 2

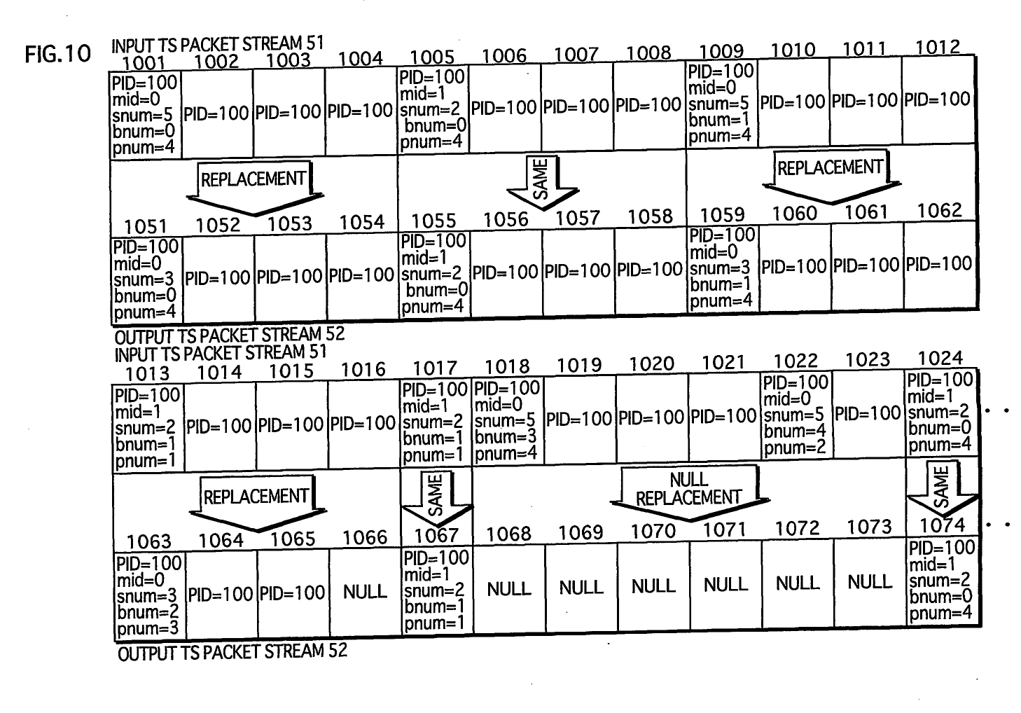

FIG. 10 shows examples of the TS packets contained in a TS packet stream (input TS packet stream 51) input into the data replacement output apparatus 20, and examples of the TS packets contained in a TS packet stream (output TS packet stream 52) output from the data replacement output apparatus 20, the output TS packet stream 52 containing the post-replacement packets or null packets replacing the replacement object packets in the input TS packet stream 51. In the examples shown in FIG. 10, it is presumed that a replacement object module of 3,000 octets is replaced with a post-replacement module of 2,000 octets.

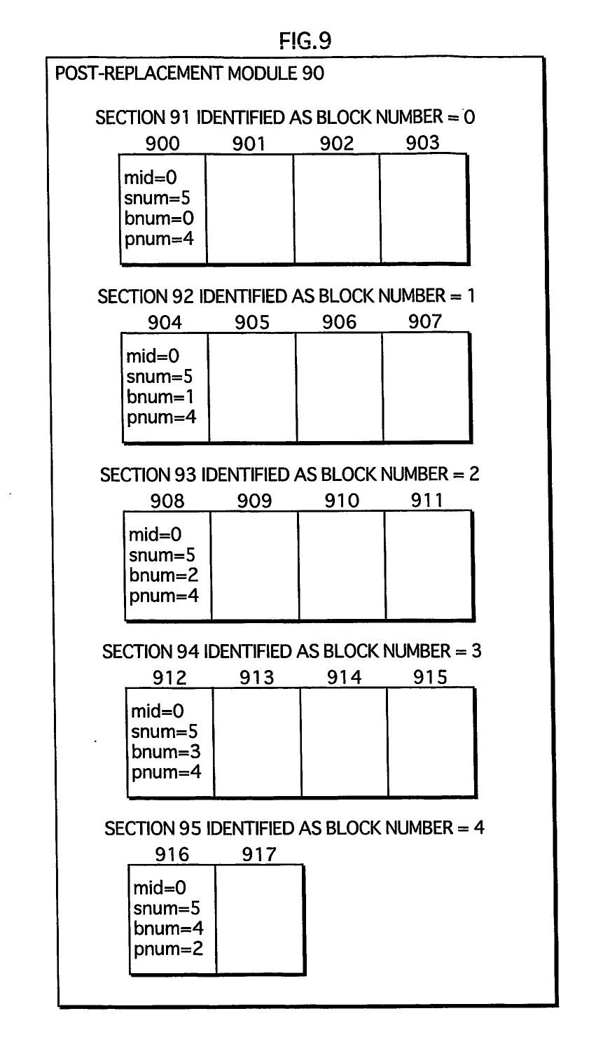

FIG. 9 shows a replacement object module 90 composed of replacement object packets shown in FIG. 10. The replacement object packets 900-903 shown in FIG. 9 correspond to replacement object packets 1001-1004 in the input TS packet stream 51 shown in FIG. 10. The replacement object packets 904-907 shown in FIG. 9 correspond to replacement object packets 1009-1012 in the input TS packet stream 51 shown in FIG. 10. The replacement object packets 908-911 shown in FIG. 9 correspond to replacement object packets 1013-1016 in the input TS packet stream 51 shown in FIG. 10. The replacement object packets 912-915 shown in FIG. 9 correspond to replacement object packets 1018-1021 in the input TS packet stream 51 shown in FIG. 10. The replacement object packets 916-917 shown in FIG. 9 respectively correspond to replacement object packets 1022-1023 in the input TS packet stream 51 shown in FIG. 10.

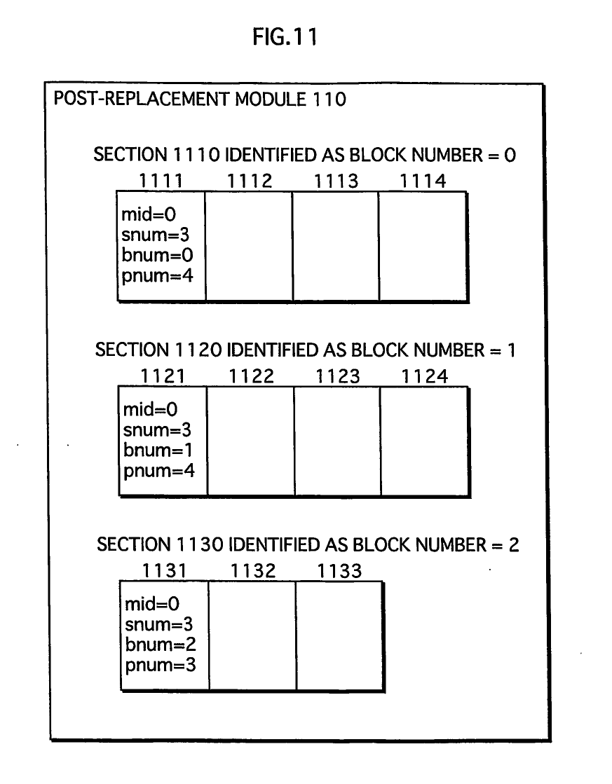

FIG. 11 shows a post-replacement module 110 composed of post-replacement packets shown in FIG. 10. The post-replacement packets 1111-1114 shown in FIG. 11 correspond to post-replacement packets 1051-1054 in the output TS packet stream 52 shown in FIG. 10. The post-replacement packets 1121-1124 shown in FIG. 11 correspond to post-replacement packets 1059-1062 in the output TS packet stream 52 shown in FIG. 10. The post-replacement packets 1131-1133 shown in FIG. 11 correspond to post-replacement packets 1063-1065 in the output TS packet stream 52 shown in FIG. 10.

Now, the operation of the replacement output control process will be explained using the specific example shown in FIG. 10.

The module replacement unit 202 acquires TS packet 1001 in the input TS packet stream 51 shown in FIG. 10 from the input data reception unit 100 (step S1201), then judges whether the acquired TS packet 1001 is a replacement object packet based on the notification of the judgment result sent from the replacement object packet determining unit 101 (step S1202).

The module replacement unit 202 judges that the acquired TS packet 1001 is a replacement object packet (“Yes” in step S1202) since it has been notified so, and proceeds to step S1203 to judge whether “in_bnum” is no larger than “out_snum”.

The TS packet 1001 belongs to a section identified as “block number=0”, thus “in_bnum” for the TS packet 1001 is “0”. As shown in FIG. 11, “section number” of the post-replacement module is “3”. As a result, the module replacement unit 202 judges that “in_bnum” is no larger than “out_snum” (“Yes” in step S1203), and proceeds to step S1204 to judge whether “in_ppos” is no larger than “out_pnum”.

The TS packet 1001 is the first TS packet of the section identified as “block number=0”, thus “in_ppos” for the TS packet 1001 is “1”. As shown in FIG. 11, the section 1110 identified as “block number=0” has “pnum=4”, thus “out_pnum=4”. As a result, the module replacement unit 202 judges that “in_ppos” is no larger than “out_pnum” (“Yes” in step S1204), and proceeds to step S1205. In step S1205, the module replacement unit 202 reads the post-replacement packet 1111 in the section 1110 identified as “block number=0” shown in FIG. 11 from the post-replacement packet holding unit 103, where the post-replacement packet 1111 is the first packet in the section and therefore corresponds to the replacement object packet having “in_ppos=1”. The module replacement unit 202 then outputs the read TS packet as the TS packet 1051 in the output TS packet stream 52 (step S1205), and returns to step S1201.

In the next rounds of the process, the module replacement unit 202 acquires TS packets 1002-1004 in the input TS packet stream 51 shown in FIG. 10 from the input data reception unit 100 (step S1201), goes through similar processes to the TS packet 1001, reads the post-replacement packets 1112-1114 in the section 1110 identified as “block number=0” shown in FIG. 11 from the post-replacement packet holding unit 103, where the post-replacement packets 1112-1114 are the second, third, and fourth packets in the section and therefore respectively correspond to the replacement object packets having “in_ppos=2”, “in_ppos=3”, and “in_ppos=4”. The module replacement unit 202 then outputs the read TS packets as the TS packets 1052-1054 in the output TS packet stream 52 (step S1205), and returns to step S1201.

In the next round of the process, the module replacement unit 202 acquires TS packet 1005 in the input TS packet stream 51 shown in FIG. 10 from the input data reception unit 100 (step S1201), then judges whether the acquired TS packet 1005 is a replacement object packet based on the notification of the judgment result sent from the replacement object packet determining unit 101 (step S1202).

The module replacement unit 202 judges that the acquired TS packet 1005 is not a replacement object packet (“No” in step S1202) since the TS packet 1005 is a non-replacement-object packet, and proceeds to step S1207. In step S1207, the module replacement unit 202 outputs the acquired TS packet 1005 as the TS packet 1055 in the output TS packet stream 52 (step S1207), and returns to step S1201.

In the next rounds of the process, the module replacement unit 202 acquires TS packets 1006-1008 in the input TS packet stream 51 shown in FIG. 10 from the input data reception unit 100 (step S1201), goes through similar processes to the TS packet 1005, outputs the acquired TS packets 1006-1008 as the TS packets 1056-1058 in the output TS packet stream 52 (step S1207), and returns to step S1201.

In the next rounds of the process, the module replacement unit 202 acquires TS packets 1009-1012 in the input TS packet stream 51 shown in FIG. 10 from the input data reception unit 100 (step S1201), goes through similar processes to the TS packet 1001, reads the post-replacement packets 1121-1124 in the section 1120 identified as “block number=1” shown in FIG. 11 from the post-replacement packet holding unit 103, where the post-replacement packets 1121-1124 are the first, second, third, and fourth packets in the section and therefore respectively correspond to the replacement object packets having “in_ppos=1”, “in_ppos=2”, “in_ppos=3”, and “in_ppos=4”. The module replacement unit 202 then outputs the read TS packets as the TS packets 1059-1062 in the output TS packet stream 52 (step S1205), and returns to step S1201.

In the next rounds of the process, the module replacement unit 202 acquires TS packets 1013-1015 in the input TS packet stream 51 shown in FIG. 10 from the input data reception unit 100 (step S1201), goes through similar processes to the TS packet 1001, reads the post-replacement packets 1131-1133 in the section 1130 identified as “block number=2” shown in FIG. 11 from the post-replacement packet holding unit 103, where the post-replacement packets 1131-1133 are the first, second, and third packets in the section and therefore respectively correspond to the replacement object packets having “in_ppos=1”, “in_ppos=2”, and “in_ppos=3”. The module replacement unit 202 then outputs the read TS packets as the TS packets 1063-1065 in the output TS packet stream 52 (step S1205), and returns to step S1201.

In the next rounds of the process, the module replacement unit 202 acquires TS packet 1016 in the input TS packet stream 51 shown in FIG. 10 from the input data reception unit 100 (step S1201), then judges whether the acquired TS packet 1016 is a replacement object packet based on the notification of the judgment result sent from the replacement object packet determining unit 101 (step S1202).

The module replacement unit 202 judges that the acquired TS packet 1016 is a replacement object packet (“Yes” in step S1202) since it has been notified so, and proceeds to step S1203 to judge whether “in_bnum” is no larger than “out_snum”.

The TS packet 1016 belongs to a section identified as “block number=2”, thus “in_bnum” for the TS packet 1016 is “2”. As shown in FIG. 11, “section number” of the post-replacement module is “3”. As a result, the module replacement unit 202 judges that “in_bnum” is no larger than “out_snum” (“Yes” in step S1203), and proceeds to step S1204 to judge whether “in_ppos” is no larger than “out_pnum”.

The TS packet 1016 is the fourth TS packet of the section identified as “block number=2”, thus “in_ppos” for the TS packet 1016 is “4”. As shown in FIG. 11, the section 1110 identified as “block number=0” has “pnum=3”, thus “out_pnum=3”. As a result, the module replacement unit 202 judges that “in_ppos” is larger than “out_pnum” (“No” in step S1204), and proceeds to step S1206. In step S1206, the module replacement unit 202 generates and outputs a null packet as the null packet 1066 in the output TS packet stream 52 (step S1206), and returns to step S1201.

In the next round of the process, the module replacement unit 202 acquires TS packet 1017 in the input TS packet stream 51 shown in FIG. 10 from the input data reception unit 100 (step S1201), goes through similar processes to the TS packet 1005, outputs the acquired TS packet 1017 as the TS packet 1067 in the output TS packet stream 52 (step S1207), and returns to step S1201.

In the next rounds of the process, the module replacement unit 202 acquires TS packet 1018 in the input TS packet stream 51 shown in FIG. 10 from the input data reception unit 100 (step S1201), then judges whether the acquired TS packet 1018 is a replacement object packet based on the notification of the judgment result sent from the replacement object packet determining unit 101 (step S1202).

The module replacement unit 202 judges that the acquired TS packet 1018 is a replacement object packet (“Yes” in step S1202) since it has been notified so, and proceeds to step S1203 to judge whether “in_bnum” is no larger than “out_snum”.

The TS packet 1018 belongs to a section identified as “block number=3”, thus “in_bnum” for the TS packet 1018 is “3”. As shown in FIG. 11, “section number” of the post-replacement module is “3”. As a result, the module replacement unit 202 judges that “in_bnum” is larger than “out_snum” (“No” in step S1203), and proceeds to step S1206. In step S1206, the module replacement unit 202 generates and outputs a null packet (step S1206), and returns to step S1201.

In the next rounds of the process, the module replacement unit 202 acquires TS packets 1019-1023 in the input TS packet stream 51 shown in FIG. 10 from the input data reception unit 100 (step S1201), goes through similar processes to the TS packet 1018, generates and outputs null packets as the null packets 1068-1073 in the output TS packet stream 52 (step S1206), and returns to step S1201.

In the next round of the process, the module replacement unit 202 acquires TS packet 1024 in the input TS packet stream 51 shown in FIG. 10 from the input data reception unit 100 (step S1201), goes through similar processes to the TS packet 1005, outputs the acquired TS packet 1024 as the TS packet 1074 in the output TS packet stream 52 (step S1207), and returns to step S1201.

The replacement output control process in Embodiment 2 can be applied only to the case where a post-replacement module is smaller than a replacement object module in data size.

The above-described replacement output control process can be applied, for example, to a case where a module is replaced with another module in accordance with the MPEG2 standard (ISO/IEC 13818-6) that defines that all the sections in a module must have the same data size except for the last section in the module.

Also, the above-described replacement output control process can be applied to a case where the data to be replaced with another data does not conform to the MPEG2 standard, or to a case where the replacement object module is transmitted in units of “sections” (in the meaning as defined in the above embodiments) and each section is larger than each corresponding section in the post-replacement module.

### Embodiment 3

A data replacement output apparatus 30 in Embodiment 3 is characterized by having, in addition to the function of the data replacement output apparatus 20 in Embodiment 2, a function to output the post-replacement module replacing the replacement object module at a bit rate that is the same as that at which the replacement object module was received even if the a section in the post-replacement module is larger than a corresponding section in the replacement object module in data size.

Construction

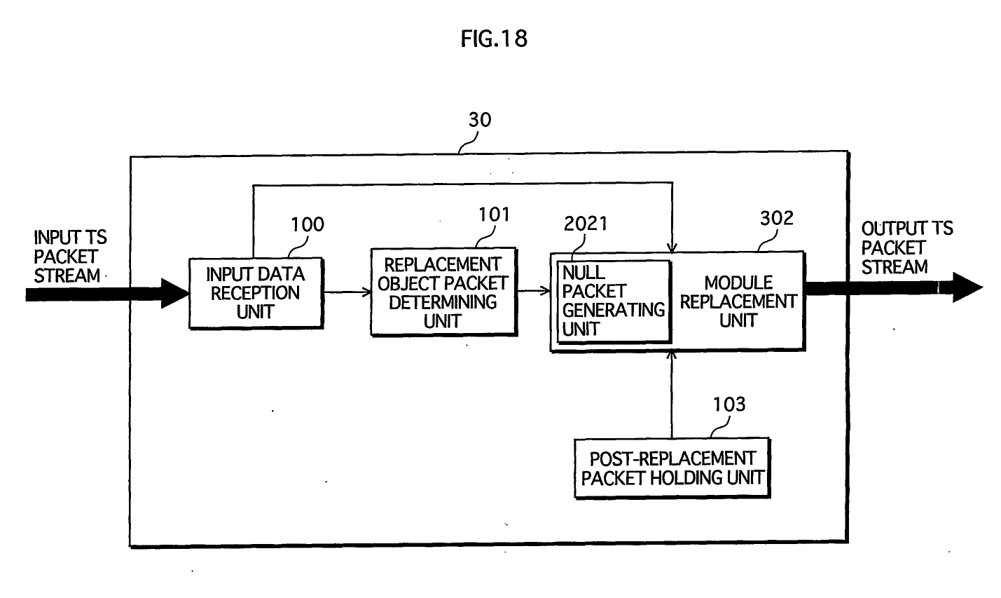

FIG. 18 is a functional block diagram showing the construction of the data replacement output apparatus 30. As shown in FIG. 18, the data replacement output apparatus 30 has the same components as the data replacement output apparatus 20 except for a module replacement unit 302. In the following description, the components having already been explained will be omitted, and mainly the replacement output control process, in which differences between the module replacement unit 302 in the present embodiment and the module replacement unit 202 in Embodiment 2 are observed, will be explained.

Operation

1. Operation of Replacement Output Control Process in Embodiment 3

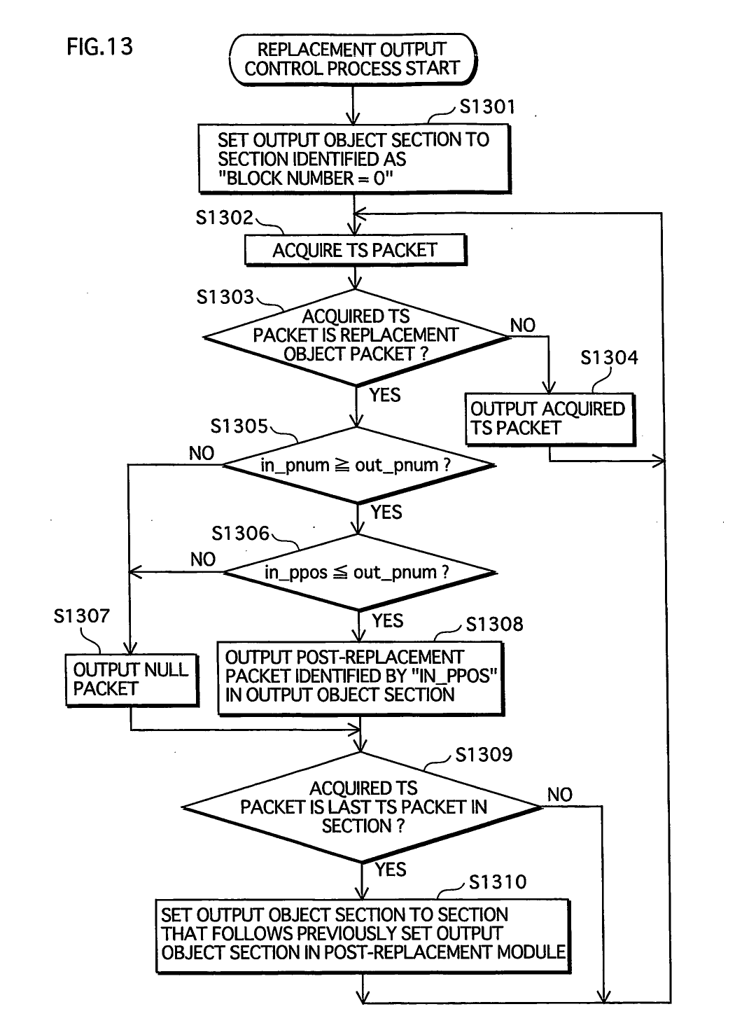

FIG. 13 is a flowchart showing the procedures of the replacement output control process performed by the data replacement output apparatus 30. Now, the operation will be described with reference to FIG. 13.

After a computer program for executing the replacement output control process is activated, the module replacement unit 302 sets an output object section to a section that is identified as “block number=0” and is held by the post-replacement packet holding unit 103 (step S1301), acquires a TS packet from the input data reception unit 100 (step S1302), and judges whether the acquired TS packet is a replacement object packet based on the notification of the judgment result sent from the replacement object packet determining unit 101 (step S1303).

If the module replacement unit 302 judges that the acquired TS packet is a replacement object packet (“Yes” in step S1303), the module replacement unit 302 compares values between “in_pnum” and “out_pnum” and judges whether “in_pnum” is no smaller than “out_pnum” (step S1305).

It should be noted here that “in_pnum” represents the number of TS packets (“pnum”) contained in the section in which the acquired TS packet is contained, and that “out_pnum” represents the number of TS packets (“pnum”) contained in the output object section.

If the module replacement unit 302 judges that “in_pnum” is no smaller than “out_pnum” (“Yes” in step S1305), the module replacement unit 302 further compares values between “in_ppos” and “out_pnum” and judges whether “in_ppos” is no larger than “out_pnum” (step S1306).

It should be noted here that as has already been explained with reference to FIG. 12, “in_ppos” is an identifier of the position of the present replacement object packet in the sequence of TS packets constituting a section.

If the module replacement unit 302 judges that “in_ppos” is no larger than “out_pnum” (“Yes” in step S1306), the module replacement unit 302 outputs a post-replacement packet identified by “in_ppos” in the output object section (step S1308), and judges whether the acquired TS packet (replacement object packet) is the last TS packet in the section to which it belongs, and judges whether “in_pnum” is no smaller than “out_pnum” (step S1309).

If the module replacement unit 302 judges negatively in step S1309 (“No” in step S1309), the module replacement unit 302 returns to step S1302. If the module replacement unit 302 judges positively in step S1309 (“Yes” in step S1309), the module replacement unit 302 sets an output object section to a section that follows the previously set output object section in the post-replacement module held by the post-replacement packet holding unit 103 (if there is no section that follows the previously set output object section in the post-replacement module, the module replacement unit 302 sets an output object section to the section set in step S1301, namely the section identified as “block number=0” (step S1310), and returns to step S1302.

If the module replacement unit 302 judges that the acquired TS packet is not a replacement object packet (“No” in step S1303), the module replacement unit 302 outputs the acquired TS packet (step S1304), and returns to step S1302.

If the module replacement unit 302 judges that “in_pnum” is smaller than “out_pnum” (“No” in step S1305), the module replacement unit 302 generates and outputs a null packet (step S1307), and proceeds to step S1309. Also, if the module replacement unit 302 judges that “in_ppos” is larger than “out_pnum” (“No” in step S1306), the module replacement unit 302 generates and outputs a null packet (step S1307), and proceeds to step S1309.

2. Specific Example of Replacement Output Control Process in Embodiment 3

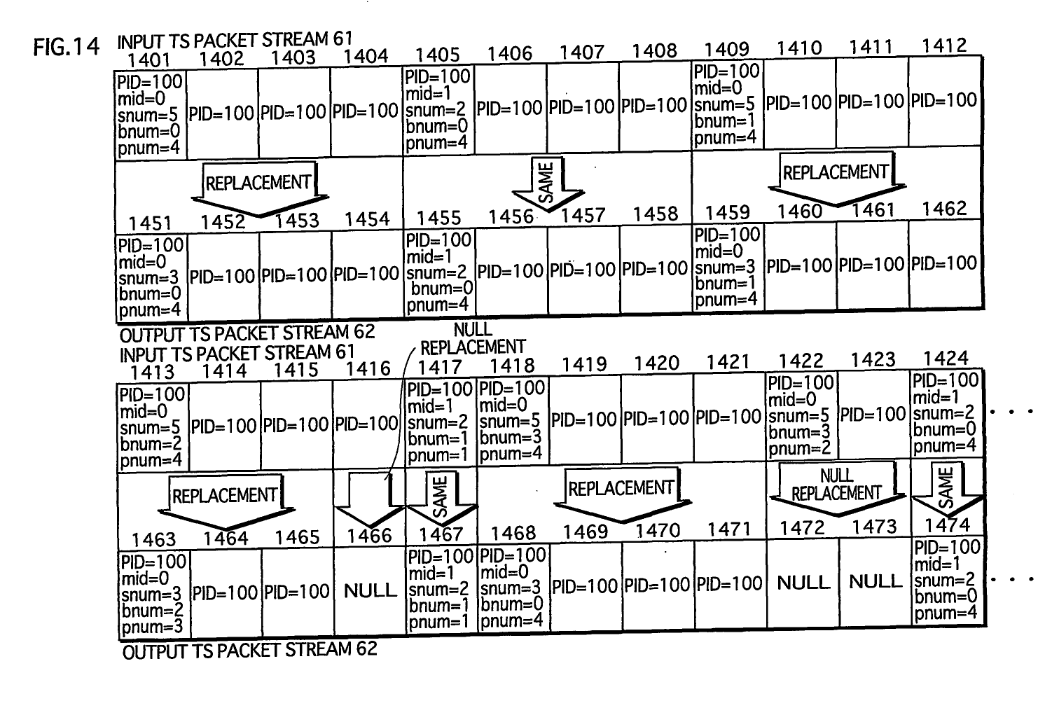

FIG. 14 shows examples of the TS packets contained in a TS packet stream (input TS packet stream 61) input into the data replacement output apparatus 30, and examples of the TS packets contained in a TS packet stream (output TS packet stream 62) output from the data replacement output apparatus 30, the output TS packet stream 62 containing the post-replacement packets or null packets replacing the replacement object packets in the input TS packet stream 61. In the examples shown in FIG. 14, it is presumed that a replacement object module of 3,000 octets is replaced with a post-replacement module of 2,000 octets.

In the input TS packet stream 61 shown in FIG. 14, TS packets 1401-1404, 1409-1412, 1413-1416, and 1418-1423 contained in a module identified as “mid=0” represent replacement object packets, and TS packets 1405-1408, 1417, and 1424 contained in a module identified as “mid=1” represent non-replacement-object packets.

Now, the operation of the replacement output control process will be explained using the specific example shown in FIG. 14.

The module replacement unit 302 sets an output object section to a section that is identified as “block number=0” and is held by the post-replacement packet holding unit 103 (step S1301), acquires TS packet 1401 that is the first TS packet in the input TS packet stream 61 shown in FIG. 14 from the input data reception unit 100 (step S1302), and judges whether the acquired TS packet 1401 is a replacement object packet based on the notification of the judgment result sent from the replacement object packet determining unit 101 (step S1303).

The module replacement unit 302 judges that the acquired TS packet is a replacement object packet (“Yes” in step S1303) since it has been notified so, and proceeds to step S1305 to judge whether “in_pnum” is no smaller than “out_pnum” (step S1305).

The section that contains the acquired TS packet 1401 contains four TS packets in total (“pnum=4”). In contrast, the section 1110 which, identified as “block number=0” as shown in FIG. 11, has been set as the output object section contains four TS packets in total (“pnum=4”). Accordingly, at this point in time, “in_pnum” and “out_pnum” are both “4”. The module replacement unit 302 therefore judges that “in_pnum” is no smaller than “out_pnum” (“Yes” in step S1305), and proceeds to step S1306 to judge whether “in_ppos” is no larger than “out_pnum” (step S1306).

The TS packet 1401 is the start packet of the section identified as “block number=0”, and therefore “in_ppos” is “1”. In contrast, as described above, the section 1110 identified as “block number=0” in FIG. 11 contains four TS packets in total (“pnum=4”), and “out_pnum” is “4”. Comparing these values, the module replacement unit 302 judges that “in_ppos” is no larger than “out_pnum” (“Yes” in step S1306). In the following step S1308, the module replacement unit 302 reads the post-replacement packet 1111, which corresponds to “in_ppos=1” since it is the first TS packet in the output object section being the section 1110 identified as “block number=0” in FIG. 11, and outputs the read post-replacement packet 1111 as TS packet 1451 in the output TS packet stream 62 shown in FIG. 14 (step S1308), then proceeds to step S1309 to judge whether the acquired TS packet 1401 is the last TS packet in the section identified as “block number=0” to which it belongs, and judge whether “in_pnum” is no smaller than “out_pnum” (step S1309). The acquired TS packet 1401 is the first TS packet in the section identified as “block number=0”. The module replacement unit 302 therefore judges that the acquired TS packet is not the last TS packet in the section to which it belongs (“No” in step S1309), and returns to step S1302.

In the next rounds of the process, the module replacement unit 302 respectively acquires TS packets 1402 and 1403 in the input TS packet stream 61 shown in FIG. 14 from the input data reception unit 100 (step S1302), goes through similar processes to the TS packet 1401, reads the post-replacement packets 1112 and 1113 in the section 1110 identified as “block number=0” shown in FIG. 11 from the post-replacement packet holding unit 103, then outputs the read TS packets as the TS packets 1452 and 1453 in the output TS packet stream 62 (step S1308), and returns to step S1302.

In the next round of the process, the module replacement unit 302 acquires TS packet 1404 in the input TS packet stream 61 shown in FIG. 14 from the input data reception unit 100 (step S1302), goes through similar processes to the TS packet 1401 except for the judgment in step S1309, reads the fourth post-replacement packet 1114 corresponding to “in_ppos=4” in the section 1110 identified as “block number=0” shown in FIG. 11 from the post-replacement packet holding unit 103, then outputs the read TS packet as the TS packet 1454 in the output TS packet stream 62 (step S1308).

In the following step S1309, the module replacement unit 302 judges that the acquired TS packet 1404 is the last TS packet in the section identified as “block number=0” to which it belongs, and judges that “in_pnum” is no smaller than “out_pnum”. Since it judges positively in step S1309 (“Yes” in step S1309), the module replacement unit 302 sets an output object section to a section (section 1120 identified as “block_number=1” shown in FIG. 11) that follows the previously set output object section (section 1110 identified as “block number=0”) in the post-replacement module held by the post-replacement packet holding unit 103 (step S1310), and returns to step S1302.

In the next rounds of the process, the module replacement unit 302 respectively acquires TS packets 1405-1408 in the input TS packet stream 61 shown in FIG. 14 from the input data reception unit 100 (step S1302), and proceeds to judge whether the acquired TS packets are replacement object packets (step S1303).

The module replacement unit 302 judges that the acquired TS packets 1405-1408 are not replacement object packets (“No” in step S1303) since it has been notified so, and outputs the acquired TS packets 1405-1408 as TS packets 1455-1458 in the output TS packet stream 62 shown in FIG. 14 (step S1304), and returns to step S1302.

In the next rounds of the process, the module replacement unit 302 respectively acquires TS packets 1409-1411 in the input TS packet stream 61 shown in FIG. 14 from the input data reception unit 100 (step S1302), goes through similar processes to the TS packet 1401, reads the post-replacement packets 1121-1123 which are the first, second, and third TS packets in the section 1120 identified as “block number=1” shown in FIG. 11 and correspond to “in_ppos=1”, “in_ppos=2”, and “in_ppos=3” from the post-replacement packet holding unit 103, then outputs the read TS packets as the TS packets 1459-1461 in the output TS packet stream 62 (step S1308), and returns to step S1302.

In the next round of the process, the module replacement unit 302 acquires TS packet 1412 in the input TS packet stream 61 shown in FIG. 14 from the input data reception unit 100 (step S1302), goes through similar processes to the TS packet 1404, reads the fourth post-replacement packet 1124 corresponding to “in_ppos=4” in the section 1120 identified as “block number=1” shown in FIG. 11 from the post-replacement packet holding unit 103, then outputs the read TS packet as the TS packet 1462 in the output TS packet stream 62 (step S1308).

In the following step S1309, the module replacement unit 302 judges that the acquired TS packet 1412 is the last TS packet in the section identified as “block number=1” to which it belongs, and judges that “in_pnum” is no smaller than “out_pnum”. Since it judges positively in step S1309 (“Yes” in step S1309), the module replacement unit 302 sets an output object section to a section (section 1130 identified as “block number=2” shown in FIG. 11) that follows the previously set output object section (section 1120 identified as “block number=1”) in the post-replacement module held by the post-replacement packet holding unit 103 (step S1310), and returns to step S1302.

In the next rounds of the process, the module replacement unit 302 respectively acquires TS packets 1413, 1414, and 1415 in the input TS packet stream 61 shown in FIG. 14 from the input data reception unit 100 (step S1302), goes through similar processes to the TS packet 1401, reads the post-replacement packets 1131 and 1132 which are the first and second TS packets in the section 1130 identified as “block number=2” shown in FIG. 11 and correspond to “in_ppos=1” and “in_ppos=2” from the post-replacement packet holding unit 103, then outputs the read TS packets as the TS packets 1463, 1464, and 1465 in the output TS packet stream 62 (step S1308), and returns to step S1302.

In the next round of the process, the module replacement unit 302 acquires TS packet 1416 in the input TS packet stream 61 shown in FIG. 14 from the input data reception unit 100 (step S1302), and proceeds to step S1303 to judge whether the acquired TS packet 1416 is a replacement object packet based on the notification of the judgment result sent from the replacement object packet determining unit 101 (step S1303).

The module replacement unit 302 judges that the acquired TS packet 1416 is a replacement object packet (“Yes” in step S1303) since it has been notified so, and proceeds to step S1305 to judge whether “in_pnum” is no smaller than “out_pnum”.

The section that contains the acquired TS packet 1416 contains four TS packets in total (“pnum=4”). In contrast, the section 1130 which, identified as “block number=2” as shown in FIG. 11, has been set as the output object section contains three TS packets in total (“pnum=3”). Accordingly, at this point in time, “in_pnum” is larger than “out_pnum”. The module replacement unit 302 therefore judges that “in_pnum” is no smaller than “out_pnum” (“Yes” in step S1305), and proceeds to step S1306 to judge whether “in_ppos” is no larger than “out_pnum” (step S1306).

The TS packet 1416 is the fourth packet of the section identified as “block number=2”, and therefore “in_ppos” is “4”. In contrast, the section 1130 identified as “block number 2” in FIG. 11 contains three TS packets in total (“pnum=3”), and “out_pnum” is “3”. Comparing these values, the module replacement unit 302 judges that “in_ppos” is larger than “out_pnum” (“No” in step S1306). In the following step the module S1307, replacement unit 302 generates and outputs a null packet as the null packet 1466 in the output TS packet stream 62 (step S1307), and proceeds to step S1309.

In step S1309, the module replacement unit 302 judges that the acquired TS packet 1416 is the last TS packet in the section identified as “block number=2” to which it belongs, and judge that “in_pnum” is no smaller than “out_pnum”. Since it judges positively in step S1309 (“Yes” in step S1309), the module replacement unit 302 sets an output object section to a section (section 1110 identified as “block number=0” shown in FIG. 11) that follows the previously set output object section (section 1130 identified as “block number=2”) in the post-replacement module held by the post-replacement packet holding unit 103 (step S1310), and returns to step S1302.

In the next round of the process, the module replacement unit 302 acquires TS packet 1417 in the input TS packet stream 61 shown in FIG. 14 from the input data reception unit 100 (step S1302), goes through similar processes to the TS packets 1405-1408, and outputs the acquired TS packet 1417 as TS packet 1467 in the output TS packet stream 62 shown in FIG. 14 (step S1304), and returns to step S1302.

In the next rounds of the process, the module replacement unit 302 respectively acquires TS packets 1418-1420 in the input TS packet stream 61 shown in FIG. 14 from the input data reception unit 100 (step S1302), goes through similar processes to the TS packets 1401-1403, reads the post-replacement packets 1111-1113 which are the first, second, and third TS packets in the section 1120 identified as “block number=0” shown in FIG. 11 and correspond to “in_ppos=1”, “in_ppos=2”, and “in_ppos=3” from the post-replacement packet holding unit 103, then outputs the read TS packets as the TS packets 1468-1470 in the output TS packet stream 62 (step S1308), and returns to step S1302.

In the next round of the process, the module replacement unit 302 acquires TS packet 1421 in the input TS packet stream 61 shown in FIG. 14 from the input data reception unit 100 (step S1302), goes through similar processes to the TS packet 1404, reads the fourth post-replacement packet 1114 corresponding to “in_ppos=4” in the section 1110 identified as “block number=0” shown in FIG. 11 from the post-replacement packet holding unit 103, then outputs the read TS packet as the TS packet 1471 in the output TS packet stream 62 (step S1308).

In step S1309, the module replacement unit 302 judges that the acquired TS packet 1421 is the last TS packet in the section identified as “block number=0” to which it belongs, and judges that “in_pnum” is no smaller than “out_pnum”. Since it judges positively in step S1309 (“Yes” in step S1309), the module replacement unit 302 sets an output object section to a section (section 1120 identified as “block number=1” shown in FIG. 11) that follows the previously set output object section (section 1110 identified as “block number=0”) in the post-replacement module held by the post-replacement packet holding unit 103 (step S1310), and returns to step S1302.

In the next rounds of the process, the module replacement unit 302 respectively acquires TS packets 1422 and 1423 in the input TS packet stream 61 shown in FIG. 14 from the input data reception unit 100 (step S1302), and respectively judges whether the acquired TS packets 1422 and 1423 are replacement object packets based on the notifications of the judgment results sent from the replacement object packet determining unit 101 (step S1303).

The module replacement unit 302 judges that the acquired TS packets are replacement object packets (“Yes” in step S1303) since it has been notified so, and proceeds to step S1305 to judge whether “in_pnum” is no smaller than “out_pnum” (step S1305).

The section that contains the acquired TS packets 1422 and 1423 contains two TS packets in total (“pnum=2”). In contrast, the section 1120 which, identified as “block number=1” as shown in FIG. 11, has been set as the output object section contains four TS packets in total (“pnum=4”). Accordingly, at this point in time, “in_pnum” is smaller than “out_pnum”. The module replacement unit 302 therefore judges that “in_pnum” is smaller than “out_pnum” (“No” in step S1305). In the following step the module S1307, replacement unit 302 generates and outputs null packets as the null packets 1472 and 1473 in the output TS packet stream 62 (step S1307). After this, in the case of acquired TS packet 1422, the module replacement unit 302 judges negatively in step S1309 since the acquired TS packet is not the last TS packet in the section to which it belongs, and returns to step S1302. Also, in the case of acquired TS packet 1423, the module replacement unit 302 judges negatively in step S1309 since the acquired TS packet is the last TS packet in the section to which it belongs but “in_pnum” is smaller than “out_pnum”. Since it judges negatively in step S1309 (“No” in step S1309), the module replacement unit 302 returns to step S1302.

In the next round of the process, the module replacement unit 302 acquires TS packet 1424 in the input TS packet stream 61 shown in FIG. 14 from the input data reception unit 100 (step S1302), goes through similar processes to the TS packets 1405-1408, and outputs the acquired TS packet 1424 as TS packet 1474 in the output TS packet stream 62 shown in FIG. 14 (step S1304), and returns to step S1302.

### Embodiment 4

A data replacement output apparatus 40 in Embodiment 4 is characterized in that if replacement object packets are contained in separate positions in the input TS packet stream, the data replacement output apparatus 40 outputs post-replacement packets after the number of input replacement object packets reaches a certain number.

Construction

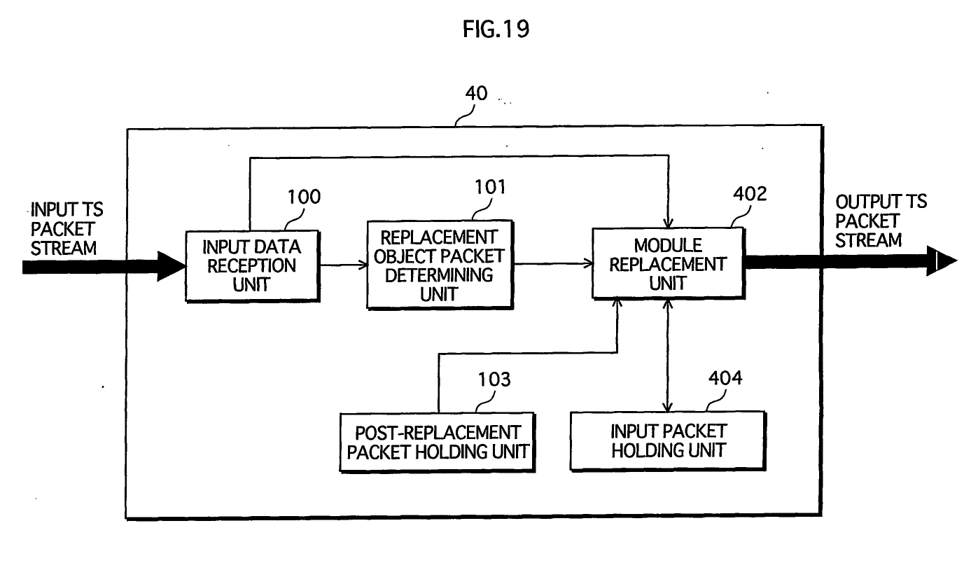

FIG. 19 is a functional block diagram showing the construction of the data replacement output apparatus 40. As shown in FIG. 19, the data replacement output apparatus 40 has the same components as the data replacement output apparatus 10 in Embodiment 1 except for an input packet holding unit 404 and a module replacement unit 402. In the following description, the components having already been explained will be omitted, and mainly the replacement output control process, in which differences between (i) the input packet holding unit 404 and the module replacement unit 402 in the present embodiment and (ii) the corresponding components in Embodiment 1 are observed, will be explained.

Operation

1. Operation of Replacement Output Control Process in Embodiment 4

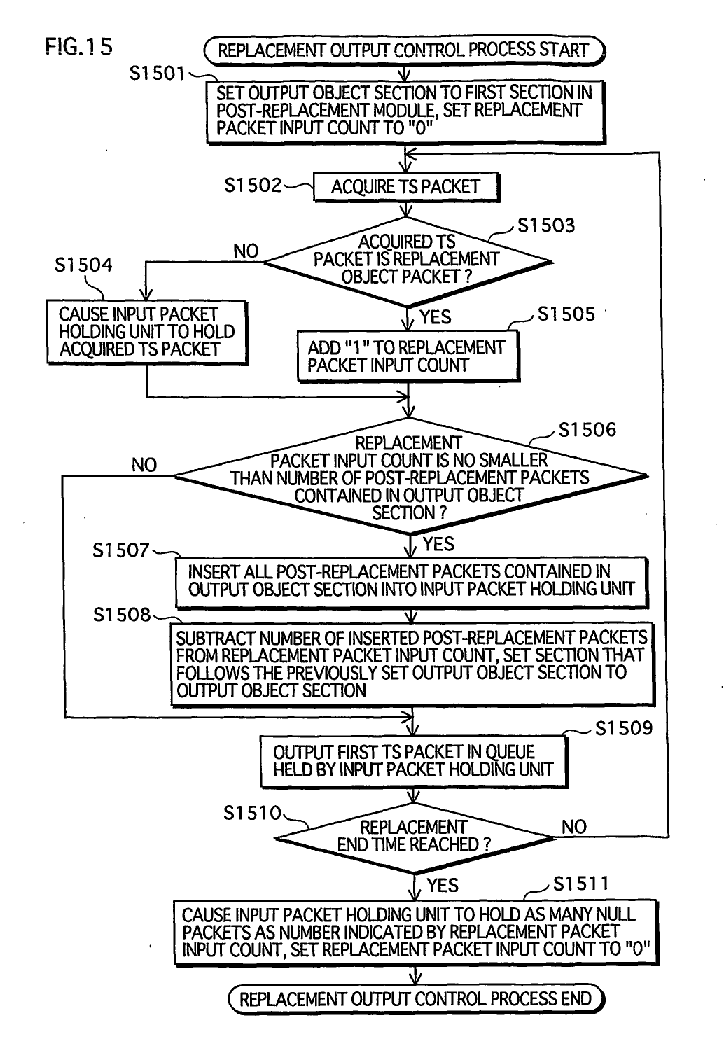

FIG. 15 is a flowchart showing the procedures of the replacement output control process performed by the data replacement output apparatus 40. Now, the operation will be described with reference to FIG. 15.

After a computer program for executing the replacement output control process is activated, the module replacement unit 402 sets an output object section to the first section in the post-replacement module held by the post-replacement packet holding unit 103, and sets a replacement packet input count to “0” (step S1501).

The replacement packet input count is a count that corresponds to a difference between the total number of the replacement object packets the module replacement unit 402 has received from the input data reception unit 100 after the computer program has been activated and the total number of post-replacement packets the module replacement unit 102 has output from the input packet holding unit 404.

Following step S1501, the module replacement unit 402 acquires a TS packet from the input data reception unit 100 (step S1502), then judges whether the acquired TS packet is a replacement object packet based on the notification of the judgment result sent from the replacement object packet determining unit 101 (step S1503).

If it judges that the acquired TS packet is a replacement object packet in step S1503 (“Yes” in step S1503), the module replacement unit 402 adds “1” to the replacement packet input count (step S1505), and judges whether the replacement packet input count is no smaller than the number of post-replacement packets contained in the output object section (step S1506).

If it judges that the replacement packet input count is no smaller than the number of post-replacement packets contained in the output object section in step S1506 (“Yes” in step S1506), the module replacement unit 402 reads all the post-replacement packets contained in the output object section in a post-replacement module held by the post-replacement packet holding unit 103, and inserts the read post-replacement packets into the queue of non-replacement-object packets held by the input packet holding unit 404 at a position following the last packet or the first section, in the order in which the post-replacement packets are arranged in the output object section (step S1507).

More specifically, in step S1507, the module replacement unit 402 searches for the last non-replacement-object packet in a section by checking each packet one by one starting with the first packet in the queue held by the input packet holding unit 404, and inserts the read post-replacement packets into the queue at a position between (i) the last-in-a-section non-replacement-object packet that is detected first and (ii) a packet that follows the detected packet. If there is no packet following the detected last non-replacement-object packet in a section, the module replacement unit 402 inserts the read post-replacement packets into the queue after the detected last non-replacement-object packet, in the order in which the post-replacement packets are arranged in the output object section.

Also, if the first packet in the queue held by the input packet holding unit 404 is the start packet, the module replacement unit 402 inserts the read post-replacement packets into the queue before the start packet, that is, at the start of the queue in the order in which the post-replacement packets are arranged in the output object section. Also, if there is no non-replacement-object packet in the queue held by the input packet holding unit 404, the module replacement unit 402 inserts the read post-replacement packets into the queue at the start of the queue in the order in which the post-replacement packets are arranged in the output object section.

Also, if the input packet holding unit 404 holds only post-replacement packets, the module replacement unit 402 inserts the read post-replacement packets into the queue at the end, in the order in which the post-replacement packets are arranged in the output object section.

The module replacement unit 402 can search for and detect the last non-replacement-object packet in a section by, for example, first searching for a non-replacement-object packet that contains the identifiers (“mid”, “bnum” or the like) other than “PID” among the non-replacement-object packets in the queue held by the input packet holding unit 404, and then determining, as the last packet in a section, anon-replacement-object packet immediately before the detected non-replacement-object packet that contains the identifiers (“mid”, “bnum” or the like) other than “PID”.

In the following step S1508, the module replacement unit 402 subtracts the number of post-replacement packets that were inserted into the queue held by the input packet holding unit 404 in step S1507 from the replacement packet input count, and sets a section that follows the previously set output object section in the post-replacement module held by the post-replacement packet holding unit 103 to a new output object section (step S1508). The module replacement unit 402 then outputs the first TS packet in the queue held by the input packet holding unit 404 (step S1509), and judges whether a predetermined replacement end time has been reached (step S1510).

If it judges that the predetermined replacement end time has been reached (“Yes” in step S1510), the module replacement unit 402 generates as many null packets as the number indicated by the replacement packet input count, causes the input packet holding unit 404 to hold the generated null packets, and sets the replacement packet input count to “0” (step S1511).

If it judges that the predetermined replacement end time has not been reached in step S1510 (“No” in step S1510), the module replacement unit 402 returns to step S1502.

If it judges that the acquired TS packet is not a replacement object packet in step S1503 (“No” in step S1503), the module replacement unit 402 causes the input packet holding unit 404 to hold the TS packet acquired in step S1502 (step S1504), and proceeds to step S1506.

If it judges that the replacement packet input count is smaller than the number of post-replacement packets contained in the output object section in step S1506 (“No” in step S1506), the module replacement unit 402 proceeds to step S1509.

2. Specific Example of Replacement Output Control Process in Embodiment 4

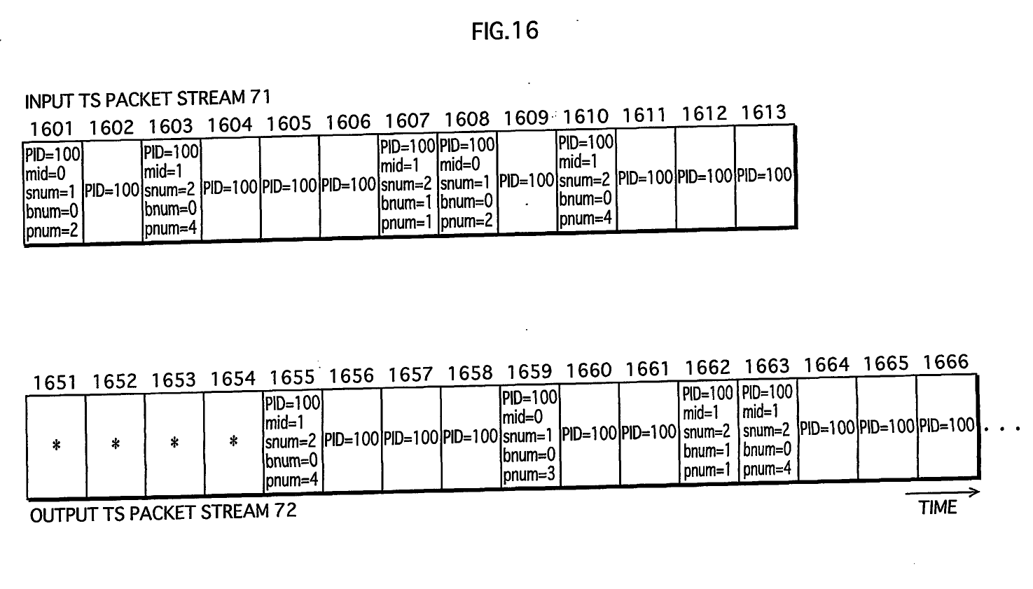

FIG. 16 shows examples of the TS packets contained in a TS packet stream (input TS packet stream 71) input into the data replacement output apparatus 40, and examples of the TS packets contained in a TS packet stream (output TS packet stream 72) output from the data replacement output apparatus 40, the output TS packet stream 72 containing a section that contains three post-replacement packets.

In the input TS packet stream 71 shown in FIG. 16, TS packets 1601, 1602, 1608, and 1609 contained in a module identified as “mid=0” are replacement object packets, and TS packets 1603-1607 and 1610-1613 contained in a module identified as “mid=1” are non-replacement-object packets. Also, TS packets 1651-1654 having the “*” mark in the box are the non-replacement-object packets that have been output from the input packet holding unit 404 in the previous the replacement output control process (if the replacement output control process has not been performed previously, the TS packets 1651-1654 are null packets held by the input packet holding unit 404). Also, TS packets 1659-1661 contained in a module identified as “mid=0” are post-replacement packets, and TS packets 1655-1658, 1662, and 1663-1666 contained in a module identified as “mid=1” are respectively non-replacement-object packets contained in the input TS packet stream 71 (TS packets 1603-1607 and 1610-1613 contained in a module identified as “mid=1”).

Now, the operation of the replacement output control process will be explained using the specific example shown in FIG. 16.

The module replacement unit 402 sets an output object section to the first section in the post-replacement module held by the post-replacement packet holding unit 103, and sets a replacement packet input count to “0” (step S1501). The module replacement unit 402 then acquires TS packet 1601 in the input TS packet stream 71 shown in FIG. 16 from the input data reception unit 100 (step S1502), then judges whether the acquired TS packet 1601 is a replacement object packet based on the notification of the judgment result sent from the replacement object packet determining unit 101 (step S1503).

The module replacement unit 402 judges that the acquired TS packet is a replacement object packet in step S1503 (“Yes” in step S1503) since it has been notified so, then adds “1” to the replacement packet input count (step S1505), and proceeds to step S1506 to judge whether the replacement packet input count is no smaller than the number of post-replacement packets contained in the output object section (step S1506).

The module replacement unit 402 judges that the replacement packet input count is smaller than the number of post-replacement packets contained in the output object section (“No” in step S1506) since at this point in time, the replacement packet input count is “1” and the number of post-replacement packets contained in the output object section is “3”. The module replacement unit 402 then outputs the first TS packet in the queue held by the input packet holding unit 404 (TS packet 1651 in the output TS packet stream 72 shown in FIG. 16) (step S1509), judges that the predetermined replacement end time has not been reached (“No” in step S1510), and returns to step S1502.

It should be noted here that it is presumed in the examples shown in FIG. 16 that the replacement end time is reached immediately after TS packet 1613 in the input TS packet stream 71 shown in FIG. 16 is acquired.

In the next round of the process, the module replacement unit 402 acquires TS packet 1602 in the input TS packet stream 71 shown in FIG. 16 from the input data reception unit 100 (step S1502), goes through similar processes to the TS packet 1601, adds “1” to the replacement packet input count, resulting in “2” (step S1505), outputs the first TS packet in the queue held by the input packet holding unit 404 as TS packet 1652 in the output TS packet stream 72 shown in FIG. 16 (step S1509), judges that the predetermined replacement end time has not been reached (“No” in step S1510), and returns to step S1502.

In the next round of the process, the module replacement unit 402 acquires TS packet 1603 in the input TS packet stream 71 shown in FIG. 16 from the input data reception unit 100 (step S1502), and proceeds to step S1503 to judge whether the acquired TS packet 1603 is a replacement object packet based on the notification of the judgment result sent from the replacement object packet determining unit 101 (step S1503).

In step S1503, the module replacement unit 402 judges that the acquired TS packet is not a replacement object packet (“No” in step S1503) since it is a non-replacement-object packet. The module replacement unit 402 then causes the input packet holding unit 404 to hold the TS packet 1603 acquired in step S1502 (step S1504), and proceeds to step S1506 to judge whether the replacement packet input count is no smaller than the number of post-replacement packets contained in the output object section (step S1506).

At this point in time, the replacement packet input count is “2”, and the number of post-replacement packets contained in the output object section is “3”. The module replacement unit 402 therefore judges that the replacement packet input count is smaller than the number of post-replacement packets contained in the output object section (“No” in step S1506). In the following step S1509, the module replacement unit 402 outputs the first TS packet in the queue held by the input packet holding unit 404 as TS packet 1653 in the output TS packet stream 72 shown in FIG. 16 (step S1509), and in the following step S1510, the module replacement unit 402 judges that the predetermined replacement end time has not been reached (“No” in step S1510), and returns to step S1502.

In the next rounds of the process, the module replacement unit 402 respectively acquires TS packets 1604-1607 in the input TS packet stream 71 shown in FIG. 16 from the input data reception unit 100 (step S1502), goes through similar processes to the TS packet 1603, and with the replacement packet input count being kept to be “2”, outputs TS packets 1654-1657 in the output TS packet stream 72 shown in FIG. 16 (step S1509), the module replacement unit 402 judges that the predetermined replacement end time has not been reached (“No” in step S1510), and returns to step S1502.

It should be noted here that among the TS packets output in step S1509, TS packets 1655-1657 correspond to TS packet 1603-1605 that had been acquired earlier and held by the input packet holding unit 404, and that at this point in time, TS packets 1606 and 1607 have been acquired and held by the input packet holding unit 404 in the order.

In the next round of the process, the module replacement unit 402 acquires TS packet 1608 in the input TS packet stream 71 shown in FIG. 16 from the input data reception unit 100 (step S1502), and proceeds to step S1503 to judge whether the acquired TS packet 1608 is a replacement object packet based on the notification of the judgment result sent from the replacement object packet determining unit 101 (step S1503).

In step S1503, the module replacement unit 402 judges that the acquired TS packet is a replacement object packet (“Yes” in step S1503) since it has been notified so, then adds “1” to the replacement packet input count (step S1505), and proceeds to step S1506 to judge whether the replacement packet input count is no smaller than the number of post-replacement packets contained in the output object section (step S1506).

In step S1506, the module replacement unit 402 judges that the replacement packet input count is no smaller than the number of post-replacement packets contained in the output object section (“Yes” in step S1506) since at this point in time, the replacement packet input count is “3” and the number of post-replacement packets contained in the output object section is “3”, then proceeds to step S1507.

As described above, at this point in time, the input packet holding unit 404 holds TS packets 1606 and 1607. TS packet 1606 is the last packet in a section identified as “bnum=0” that is the first section in a module identified as “mid=1”. TS packet 1607 is the first packet in a section identified as “bnum=1” that is the second section in the module identified as “mid=1”. As a result, the last non-replacement-object packet in the first section in the queue held by the input packet holding unit 404 that is detected by the module replacement unit 402 is TS packet 1606.

The module replacement unit 402 reads three post-replacement packets currently contained in the output object section in a post-replacement module held by the post-replacement packet holding unit 103, and inserts the read three post-replacement packets into the queue of non-replacement-object packets held by the input packet holding unit 404 at a position following the last packet (TS packet 1606) of the first section, in the order in which the post-replacement packets are arranged in the output object section (step S1507). In the following step S1508, the module replacement unit 402 subtracts “3” that is the number of post-replacement packets inserted into the queue held by the input packet holding unit 404 in step S1507 from “3” that is the replacement packet input count, setting the replacement packet input count to the result “0”, and sets a section that follows the previously set output object section in the post-replacement module held by the post-replacement packet holding unit 103 to a new output object section (step S1508). The module replacement unit 402 then outputs the first TS packet (TS packet 1606) in the queue held by the input packet holding unit 404 as TS packet 1658 in the output TS packet stream 72 (step S1509), judges in the next step S1510 that the predetermined replacement end time has not been reached (“No” in step S1510), and returns to step S1502.

In the next round of the process, the module replacement unit 402 acquires TS packet 1609 in the input TS packet stream 71 shown in FIG. 16 from the input data reception unit 100 (step S1502), goes through similar processes to the TS packet 1601, adds “1” to the replacement packet input count, resulting in “2” (step S1505), outputs the first TS packet in the queue held by the input packet holding unit 404 as TS packet 1659 in the output TS packet stream 72 shown in FIG. 16 (step S1509), judges that the predetermined replacement end time has not been reached (“No” in step S1510), and returns to step S1502.

In the next rounds of the process, the module replacement unit 402 respectively acquires TS packets 1610-1613 in the input TS packet stream 71 shown in FIG. 16 from the input data reception unit 100 (step S1502), goes through similar processes to the TS packet 1603, and with the replacement packet input count being kept to be “1”, outputs TS packets 1660-1663 in the output TS packet stream 72 shown in FIG. 16 (step S1509), the module replacement unit 402 judges that the predetermined replacement end time has not been reached in the cases of TS packets 1610-1612 (“No” in step S1510), and returns to step S1502.

As described earlier, the replacement end time is reached immediately after TS packet 1613 is acquired. Accordingly, in step S1510 in the round of processes for TS packet 1613, the module replacement unit 402 judges that the predetermined replacement end time has been reached (“Yes” in step S1510), and proceeds to step S1511 in which the module replacement unit 402 generates one null packet as indicated by the value “1” of the replacement packet input count, causes the input packet holding unit 404 to hold the generated null packet, and sets the replacement packet input count to “0” (step S1511).

After step S1511 is completed, the replacement output control process ends. TS packets that are acquired after this are held by the input packet holding unit 404 in the queue, then output one by one by the module replacement unit 402 each time it acquires a TS packet.

### Embodiment 5

A data replacement output apparatus 50 in Embodiment 5 is characterized by outputting post-replacement modules each of which replaces a plurality of replacement object modules corresponding to the post-replacement module.

Construction

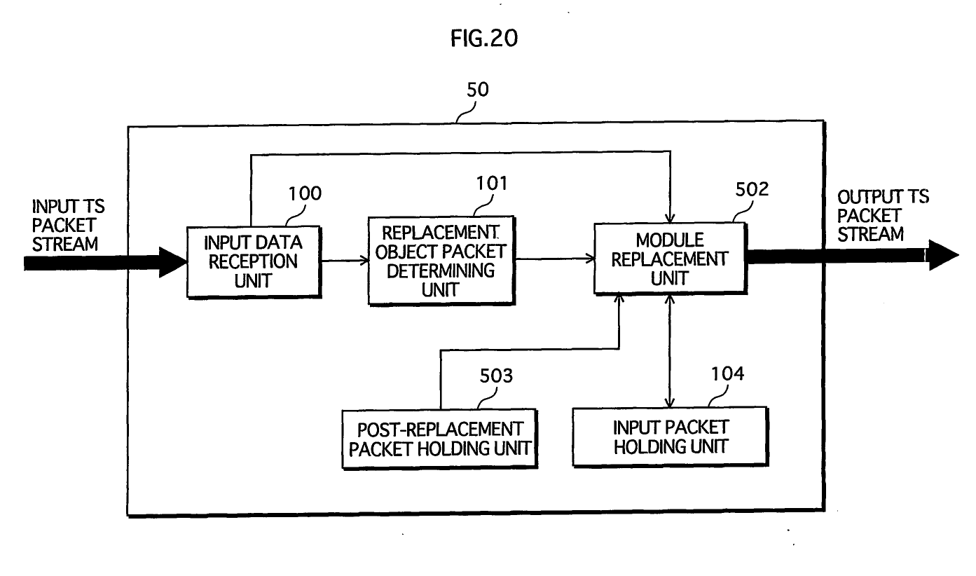

FIG. 20 is a functional block diagram showing the construction of the data replacement output apparatus 50. As shown in FIG. 20, the data replacement output apparatus 50 has the same components as the data replacement output apparatus 10 in Embodiment 1 except for a post-replacement packet holding unit 503 and a module replacement unit 502. In the following description of the construction of the data replacement output apparatus 50, the components having already been explained will be omitted, and mainly the differences will be explained.

The post-replacement packet holding unit 503 has in advance a replacement excess count correspondence table that shows correspondences among “module ID” values of “corresponding post-replacement modules”, “output section numbers”, and the replacement excess counts of the corresponding post-replacement modules, where the “output section numbers” are block numbers of sections that have been output most recently in respective corresponding post-replacement modules. The post-replacement packet holding unit 503 also has the corresponding post-replacement modules that are shown in the table.

The “corresponding post-replacement module” is a post-replacement module that corresponds to a plurality of types of replacement object modules that were input from outside. More specifically, the corresponding post-replacement modules and the replacement object modules that are correlated with each other have the same module IDs in common.

The replacement excess count is a count that corresponds to a difference between the total number of post-replacement packets (hereinafter referred to as corresponding post-replacement packets) constituting the corresponding post-replacement modules that were output from the data replacement output apparatus 50 and the total number of the replacement object packets constituting the plurality of types of replacement object modules that were input from outside. The replacement excess count is calculated for each corresponding post-replacement module by the module replacement unit 502, and the calculated value of the replacement excess count is stored in the replacement excess count correspondence table.

Now, the replacement output control process, in which differences between the module replacement unit 502 in the present embodiment and the module replacement unit 102 in Embodiment 1 are observed, will be explained.

Operation

1. Operation of Replacement Output Control Process in Embodiment 5

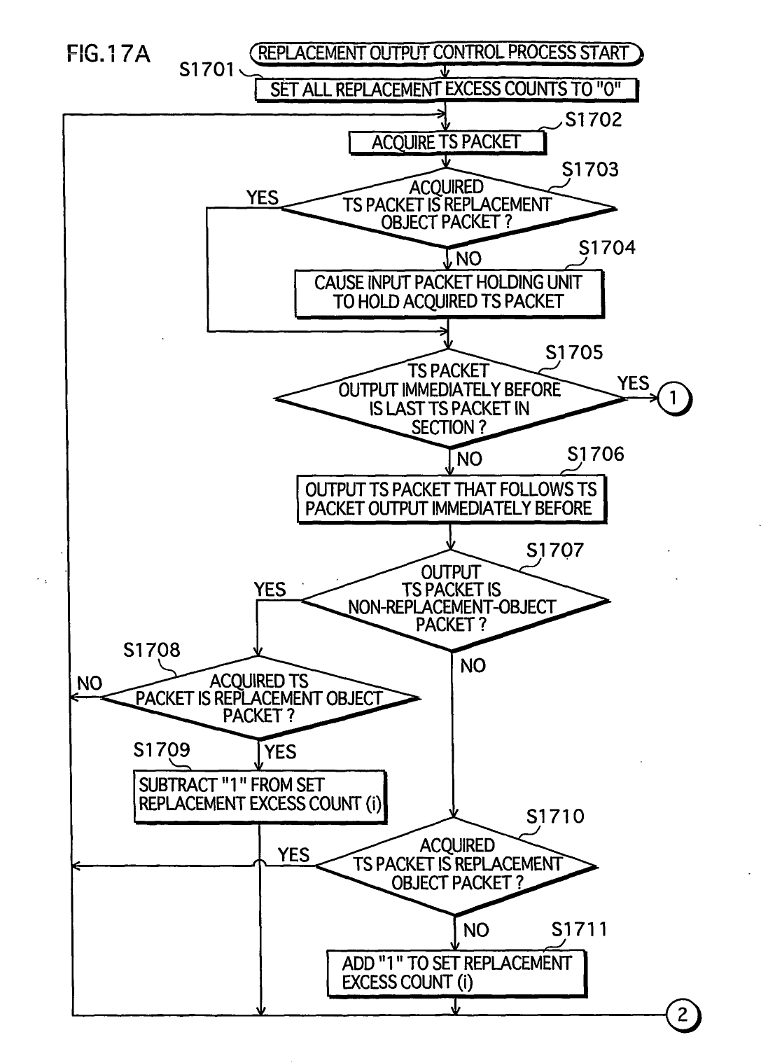

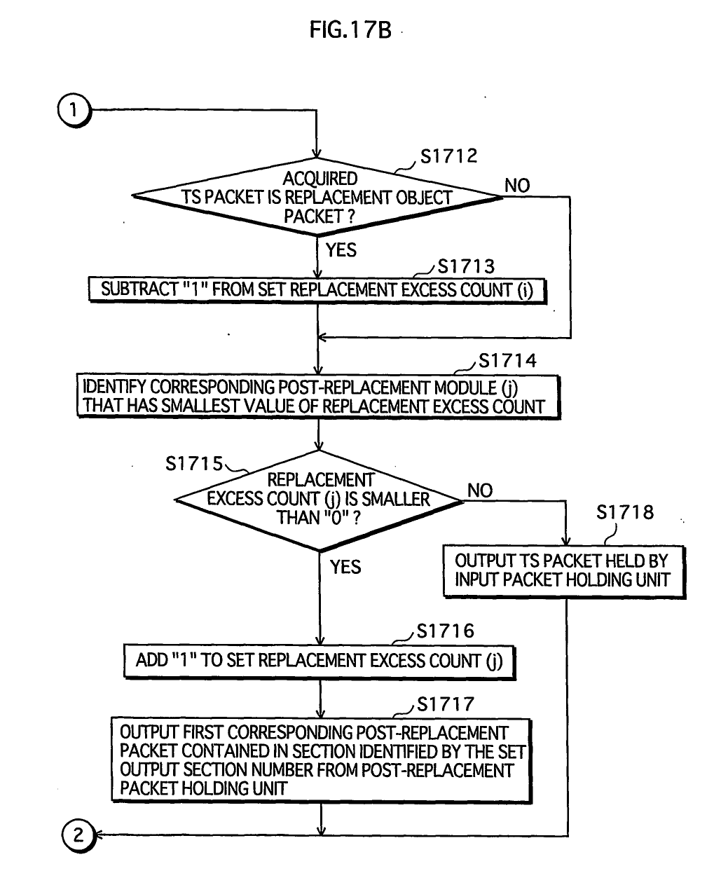

FIGS. 17A and 17B are a flowchart showing the procedures of the replacement output control process performed by the data replacement output apparatus 50. Now, the operation will be described with reference to FIGS. 17A and 17B.

After a computer program for executing the replacement output control process is activated, the module replacement unit 502 sets all the replacement excess counts to “0” (step S1701).

The module replacement unit 502 then acquires a TS packet from the input data reception unit 100 (step S1702), and judges whether the acquired TS packet is a replacement object packet based on the notification of the judgment result sent from the replacement object packet determining unit 101 (step S1703).

If it judges that the acquired TS packet is not a replacement object packet in step S1703 (“No” in step S1703), the module replacement unit 502 causes the input packet holding unit 404 to hold the TS packet acquired in step S1702 (step S1704), and proceeds to step S1705.

In step S1705, the module replacement unit 502 judges whether the module replacement unit 502 has output any TS packet prior to this step, and if it has output any TS packet, and judges whether a TS packet having been output immediately before is the last TS packet in the section to which the TS packet output immediately before belongs (step S1705).

If it judges that the acquired TS packet is a replacement object packet in step S1703 (“Yes” in step S1703), the module replacement unit 502 proceeds to step S1705.

If the module replacement unit 502 judges in step S1705 that it has not output any TS packet prior to this step, or that a TS packet having been output immediately before is the last TS packet in the section to which the TS packet output immediately before belongs (“Yes” in step S1705), the module replacement unit 502 proceeds to step S1712 to judge whether the acquired TS packet is a replacement object packet based on the notification of the judgment result sent from the replacement object packet determining unit 101 (step S1712).

If it judges that the acquired TS packet is a replacement object packet in step S1712 (“Yes” in step S1712), the module replacement unit 502 proceeds to step S1713. In step S1713, the module replacement unit 502 refers to the replacement excess count correspondence table and identifies a corresponding post-replacement module (hereinafter referred to as “corresponding post-replacement module (i)”) that corresponds to the module ID (presumed to be “i” in the present embodiment) of the module containing the section that contains the acquired packet, where module ID is included in the start packet of the section. The module replacement unit 502 then subtracts “1” from the replacement excess count (hereinafter referred to as “replacement excess count (i)”) of the corresponding post-replacement module (i), and sets the replacement excess count (i) to the result value (step S1713).

In the following step S1714, the module replacement unit 502 refers to the replacement excess count correspondence table and identifies a corresponding post-replacement module (hereinafter referred to as “corresponding post-replacement module (j)”) that has the smallest value of replacement excess count (hereinafter referred to as “replacement excess count (j)”) in the table, and is identified by “module ID=j” in the present embodiment (step S1714). In the following step S1715, the module replacement unit 502 judges whether the replacement excess count (j) is smaller than “0” (step S1715).

If it judges that the replacement excess count (j) is smaller than “0” (“Yes” in step S1715), the module replacement unit 502 adds “1” to the replacement excess count (j), and sets the replacement excess count (j) to the result value (step S1716). In the following step S1717, the module replacement unit 502 sets the output section number of the corresponding post-replacement module (j) to the next block number (if no next block number is found, sets the output section number to “0” as in “block number=0”), outputs the first corresponding post-replacement packet contained in the section identified by the output section number from the post-replacement packet holding unit 503 (step S1717), and returns to step S1702.

If it judges that the replacement excess count (j) is no smaller than “0” (“No” in step S1715), the module replacement unit 502 outputs the first TS packet among those held by the input packet holding unit 104 (step S1718), and returns to step S1702.

If the module replacement unit 502 judges in step S1705 that it has output any TS packet prior to this step, and that a TS packet having been output immediately before is not the last TS packet in the section to which the TS packet output immediately before belongs (“No” in step S1705), the module replacement unit 502 reads, from either the post-replacement packet holding unit 503 or the input packet holding unit 104, a TS packet that, in the same section, follows the TS packet having been output immediately before, and outputs the read TS packet (step S1706). The module replacement unit 502 then judges whether the TS packet output in step S1706 is a non-replacement-object packet based on whether the output TS packet was read from the input packet holding unit 104 (step S1707).

If it judges that the output TS packet is a non-replacement-object packet (“Yes” in step S1707), the module replacement unit 502 further judges whether the acquired TS packet is a replacement object packet (step S1708).

If the module replacement unit 502 judges in step S1708 that the acquired TS packet is a replacement object packet (“Yes” in step S1708), the module replacement unit 502 proceeds to step S1709. In step S1709, the module replacement unit 502 refers to the replacement excess count correspondence table and identifies a corresponding post-replacement module (hereinafter referred to as “corresponding post-replacement module (i)”) that corresponds to the module ID (presumed to be “i” in the present embodiment) of the module containing the section that contains the acquired packet, where module ID is included in the start packet of the section. The module replacement unit 502 then subtracts “1” from the replacement excess count (hereinafter referred to as “replacement excess count (i)”) of the corresponding post-replacement module (i), and sets the replacement excess count (i) to the result value (step S1709), and returns to step S1702. Also, if the module replacement unit 502 judges in step S1708 that the acquired TS packet is not a replacement object packet (“No” in step S1708), the module replacement unit 502 returns to step S1702.

If the module replacement unit 502 judges in step S1707 that the output TS packet is a replacement object packet (“No” in step S1707), the module replacement unit 502 further judges whether the acquired TS packet is a replacement object packet (step S1710).

If the module replacement unit 502 judges in step S1710 that the acquired TS packet is not the replacement-object packet (i) (“No” in step S1710), the module replacement unit 502 refers to the replacement excess count correspondence table and identifies the corresponding post-replacement module (i) to which the output TS packet belongs, and adds “1” to the replacement excess count (i) of the corresponding post-replacement module (i), and sets the replacement excess count (i) to the result value (step S1711), and returns to step S1702. Also, if the module replacement unit 502 judges in step S1710 that the acquired TS packet is the replacement-object packet (i) (“Yes” in step S1710), the module replacement unit 502 returns to step S1702.

Modifications

Up to now, five embodiments of the data replacement output apparatus of the present invention have been explained, but not limited to the above-described embodiments, the present invention may be modified as follows.

(1) In the example of the replacement output control process in Embodiment 1, the replacement object module and the post-replacement module have the same module ID (module ID=0). However, the replacement object module and the post-replacement module may have different module IDs.

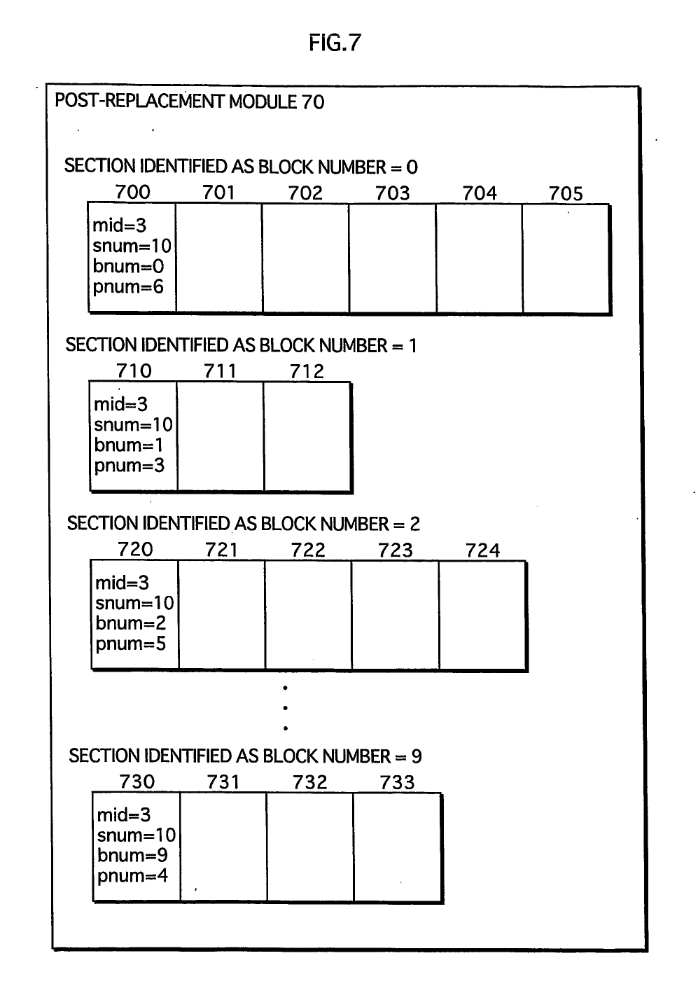

For example, in the example of the replacement output control process in Embodiment 1, the replacement object module may be replaced with the post-replacement module 70 that is shown in FIG. 7, identified as “module ID=3”, and has the same data structure as the post-replacement module 50 shown in FIG. 5 identified as “module ID=0”, with which the replacement object module is replaced in Embodiment 1.

Also, the module ID of the post-replacement module may be changed when the post-replacement module is output. In this case, post-replacement modules having different module IDs need not be prepared in advance. Also, in this case, the values for the cyclic redundancy check are determined in accordance with the value of the module ID.

(2) Embodiment 4, the module replacement unit 402 judges whether the replacement packet input count is no smaller than the number of post-replacement packets contained in the output object section in step S1506 of the flowchart of the replacement output control process shown in FIG. 15. However, in this step, the module replacement unit may compare the replacement packet input count with a value that is smaller than the number of post-replacement packets, such as half of the number of post-replacement packets or one third of the number of post-replacement packets.

Such an arrangement reduces the rime required to output the post-replacement packet, enabling the viewers to view the data broadcast of the post-replacement packets with less waiting time.

(3) In Embodiment 5, the module replacement unit 502 identifies a corresponding post-replacement module that has the smallest value of replacement excess count that is smaller than “0”, and outputs corresponding post-replacement packets contained in the identified corresponding post-replacement module in steps S1714 and S1715 of the flowchart of the replacement output control process shown in FIGS. 17A and 17B. However, priority levels may be assigned to the corresponding post-replacement modules in advance, and then the module replacement unit may identify a corresponding post-replacement module having the highest 6 priority level and having a value of replacement excess count smaller than “0” to output the corresponding post-replacement packets contained therein.

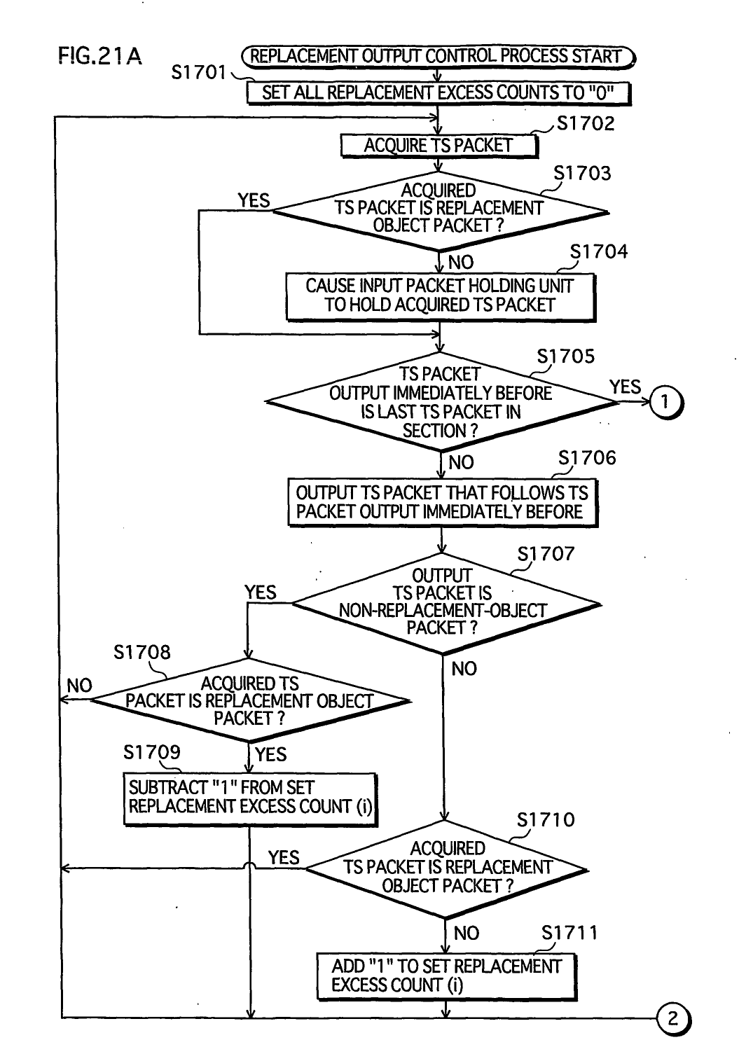

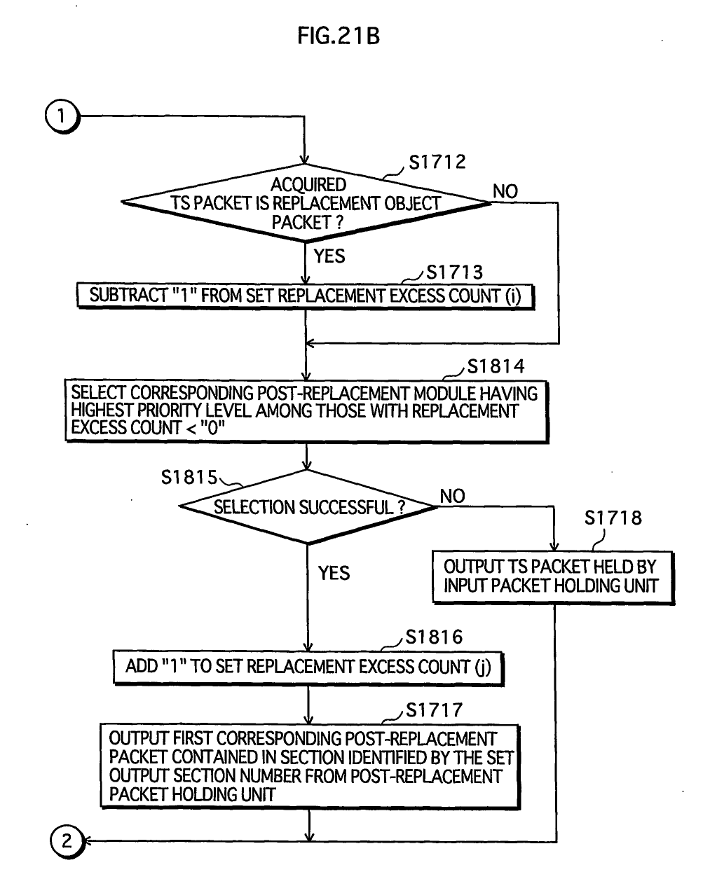

For example, the module replacement unit 502 may perform, instead of steps S1714-S1715, the following step S1814. That is to say, in step S1814, the module replacement unit 502 attempts to select a corresponding post-replacement module that has a module ID with the highest priority level and has a value of replacement excess count smaller than “0”. Then in step S1815, the module replacement unit 502 judges whether the selection in step S1814 has been successful. If it judges in step S1815 that the selection has been successful (“Yes” in step S1815), the module replacement unit 502 proceeds to step S1816 in which it adds “1” to the replacement excess count (referred to as replacement excess count (j)) of the corresponding post-replacement module selected in step S1814, and sets the replacement excess count (j) to the result value, then moves to step S1717. If it judges in step S1815 that the selection has not been successful (“No” in step S1815), the module replacement unit 502 proceeds to step S1718. FIGS. 21A and 21B are a flowchart showing the procedures of Modification (1) of the replacement output control process shown in FIGS. 17A and 17B performed by the data replacement output apparatus 50.

It should be noted here that in step S1814, the module replacement unit 502 may automatically select a corresponding post-replacement module that has the smallest or largest value of module ID among a plurality of selectable corresponding post-replacement modules. Alternatively, in step S1814, the module replacement unit 502 may select a corresponding post-replacement module that has the smallest value of replacement excess count among a plurality of selectable corresponding post-replacement modules.

It should be noted here that in Modification (1), priority levels may be assigned to non-replacement-object packets, as well. In this case, if it judges in step S1815 that the selection has been successful (“Yes” in step S1815), the module replacement unit 502 proceeds to a step to compare the priority levels between a replacement object packet and a non-replacement-object packet. If it judges in the step that the non-replacement-object packet has a higher priority level than the replacement object packet, the module replacement unit 502 proceeds to step S1718, and otherwise, the module replacement unit 502 proceeds to step S1816.

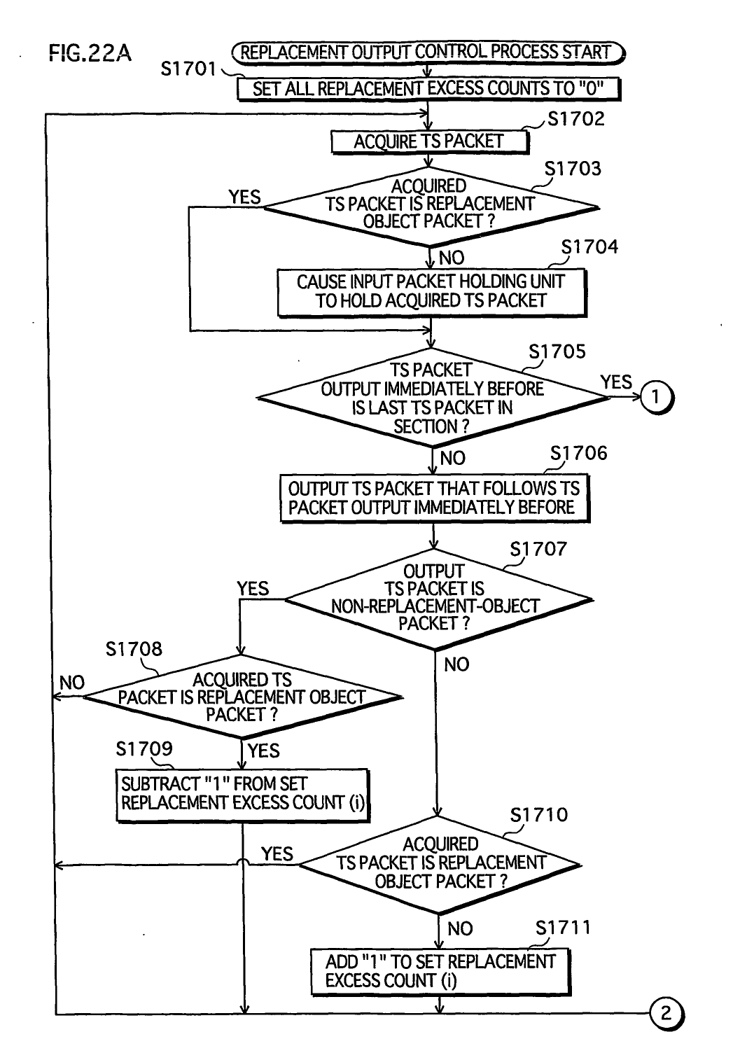

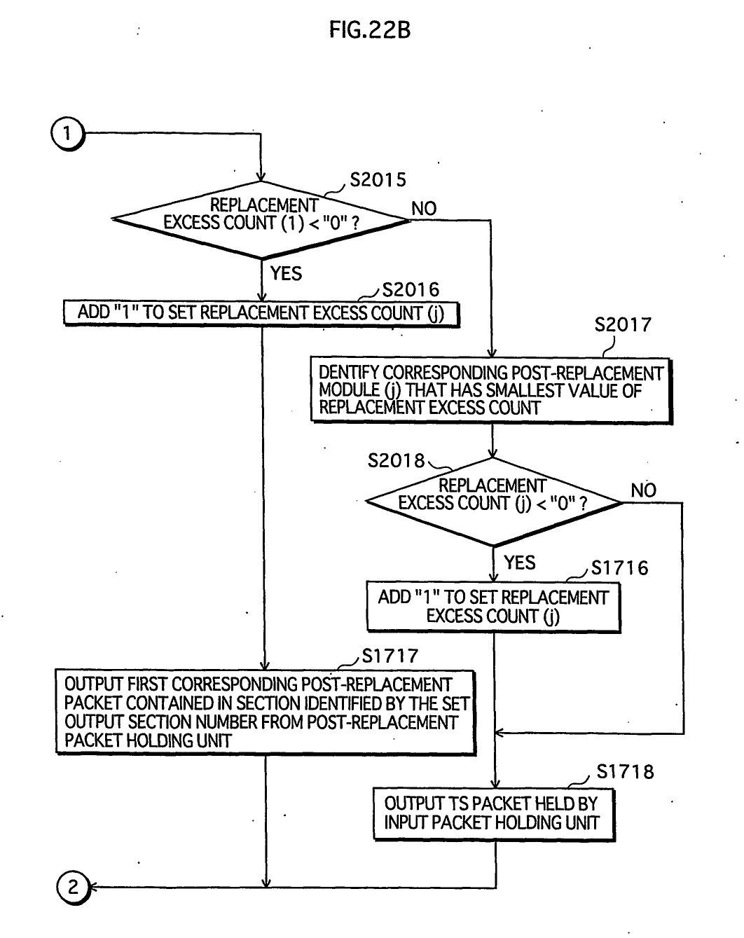

The above-described operation may be achieved by another method in which priority levels are not used. For example, one of a plurality of corresponding post-replacement modules may be determined as a highest-priority module in advance, and the module replacement unit 502 may perform, instead of steps S1714-S1715, the following step S2015. That is to say, in step S2015, the module replacement unit 502 judges whether the replacement excess count (referred to as replacement excess count (1)) of the highest-priority module is smaller than “0” (step S1715). In this case, if it judges in step S2015 that the replacement excess count (1) is smaller than “0” (“Yes” in step S2015), the module replacement unit 502 proceeds to step 2016 to add “1” to the replacement excess count (1) and set the replacement excess count (1) to the result value, then proceeds to step S1717. If it judges in step S2015 that the replacement excess count (1) is no smaller than “0” (“No” in step S2015), the module replacement unit 502 proceeds to steps S2017 and S2018 which are the same as steps S1714 and S1715 shown in FIGS. 17A and 17B. FIGS. 22A and 22B are a flowchart showing the procedures of Modification (3) of the replacement output control process shown in FIGS. 17A and 17B performed by the data replacement output apparatus 50.

(4) In Embodiment 5, in the replacement output control process shown in FIGS. 17A and 17B, the module replacement unit 502 calculates the replacement excess count for each corresponding post-replacement module to use it in controlling the output of corresponding post-replacement packets contained in the corresponding post-replacement module. However, the module replacement unit may further calculate a total replacement excess count that is the total of replacement excess counts of all corresponding post-replacement module.

For example, in the flowchart shown in FIGS. 17A and 17B, the module replacement unit 502 may perform step S2101 to set the total replacement excess count to “0”, in addition to step S1701. The module replacement unit 502 then further performs a step to subtract “1” from the total replacement excess count and set the total replacement excess count to the result value, in addition to step S1709. The module replacement unit 502 then further performs a step to subtract “1” from the total replacement excess count and set the total replacement excess count to the result value, in addition to step S1709. The module replacement unit 502 then further performs steps respectively to add “1” to the total replacement excess count and set the total replacement excess count to the result value, in addition to steps S1711 and S1716. The module replacement unit 502 then judges in step S1715 whether the replacement excess count (j) is smaller than “0” and the total replacement excess count is smaller than “0”. If it judges positively in step S1715, the module replacement unit 502 proceeds to step S1717.

This arrangement prohibits corresponding post-replacement modules from being output excessively, and reduces the delay in outputting the corresponding post-replacement modules.

(5) In Embodiments 1, 4, and 5, the received non-replacement-object packets are held by the input packet holding unit 104 or 404. However, the received non-replacement-object packets may be held by the post-replacement packet holding unit 103 or 503 in units of modules in advance. Then, post-replacement packets corresponding to the non-replacement-object packets may be output from the post-replacement packet holding unit 103 or 503.

(6) In Embodiments 1-5, the data transmission is performed in accordance with the MPEG2 standard. However, the present invention may be applied to other cases that do not conform to the MPEG2 standard

### INDUSTRIAL APPLICABILITY

The present invention is applicable to a technology used by a data replacement output apparatus to receive a unit of data from outside, replace part of the received data with corresponding data, and output the unit of data with the replacement.

1. A data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data replacement output apparatus comprising:
a determining unit operable to determine whether to perform a sequential output of a predetermined number of units of data constituting the replacement data, based on a result of comparison between (i) a total number of units of data constituting the replacement object data that have been received during a time period from a reference time to a current time and (ii) a total number of units of data constituting the replacement data that have been output during the time period, the determination being made each time a unit of data constituting the replacement object data is received while the sequential output of data is not performed; and
a data output unit operable to, if the determining unit determines to perform the sequential output of data, perform the sequential output of data by outputting a unit of data constituting the replacement data each time a unit of data constituting the data stream is received, operable to output a unit of data constituting the non-replacement-object data each time a u nit of data constituting the non-replacement-object data is received while the sequential output of data is not performed, and operable to, if the determining unit determines not to perform the sequential output of data, output a unit of data constituting the non-replacement-object data each time a unit of data constituting the data stream is received.

2. The data replacement output apparatus of claim 1, wherein
the determining unit includes:
a judging sub-unit operable to, each time a unit of data is received, judge whether the received unit of data constitutes the replacement object data; and
a comparing sub-unit operable to compare the total number of units of data constituting the replacement object data that have been received during the time period with the total number of units of data constituting the replacement data that have been output during the time period, wherein
the determining unit determines to perform the sequential output of data if it is found as a result of the comparison by the comparing sub-unit that the total number of units of data constituting the replacement data that have been output during the time period is no larger than the total number of units of data constituting the replacement object data that have been received during the time period.

3. The data replacement output apparatus of claim 2, wherein
the data output unit includes
a storage sub-unit operable to store the non-replacement-object data, and
the data output unit reads a unit of data constituting the non-replacement-object data from the storage sub-unit and outputs the read unit of data each time a unit of data constituting the non-replacement-object data is received while the sequential output of data is not performed, and if the determining unit determines not to perform the sequential output of data, reads a unit of data constituting the non-replacement-object data from the storage sub-unit and outputs the read unit of data each time a unit of data constituting the data stream is received.

4. The data replacement output apparatus of claim 1, wherein
the determining unit includes:
a judging sub-unit operable to, each time a unit of data is received, judge whether the received unit of data constitutes the replacement object data;
a calculating sub-unit operable to calculate a replacement excess count value by subtracting (i) the total number of units of data constituting the replacement data that have been output during the time period from (ii) the total number of units of data constituting the replacement object data that have been received during the time period; and
a count value judging sub-unit operable to judge whether the replacement excess count value is smaller than the predetermined number as in the predetermined number of units of data constituting the replacement data that are output sequentially, and
the determining unit determines to perform the sequential output of data if the count value judging sub-unit judges that the replacement excess count value is no smaller than the predetermined number.

5. The data replacement output apparatus of claim 1, wherein
the determining unit includes:
a judging sub-unit operable to, each time a unit of data is received, judge whether the received unit of data constitutes the replacement object data;
a calculating sub-unit operable to calculate a replacement excess count value by subtracting (i) the total number of units of data constituting the replacement data that have been output during the time period from (ii) the total number of units of data constituting the replacement object data that have been received during the time period; and
a count value judging sub-unit operable to judge whether the replacement excess count value is no smaller than half of the predetermined number as in the predetermined number of units of data constituting the replacement data that are output sequentially, and
the determining unit determines to perform the sequential output of data if the count value judging sub-unit judges that the replacement excess count value is no smaller than half of the predetermined number.

6. The data replacement output apparatus of claim 1, wherein
the data stream includes a plurality of types of replacement object data,
the data output unit includes
a replacement data storage sub-unit operable to store a plurality of types of replacement data that respectively correspond to the plurality of types of replacement object data, and
the determining unit determines whether to perform the sequential output of a predetermined number of units of data constituting any of the plurality of types of replacement data, based on a result of comparison between each pair of (i) a total number of units of data constituting one of the plurality of types of replacement object data that have been received during the time period and (ii) a total number of units of data constituting one of the plurality of types of replacement data, which corresponds to the type of replacement object data in (i), that have been output during the time period.

7. The data replacement output apparatus of claim 6, wherein
the determining unit calculates the replacement excess count value for each pair of a type of replacement object data and a corresponding type of replacement data, and
if one or more replacement excess count values calculated by the determining unit are smaller than “0”, the determining unit selects a type of replacement data among one or more types of replacement data corresponding to the one or more replacement excess count values that are smaller than “0”, based on a predetermined criterion, and determines to perform the sequential output of a predetermined number of units of data constituting the selected type of replacement data.

8. The data replacement output apparatus of claim 7, wherein
the determining unit selects a type of replacement data that corresponds to the smallest value among the one or more replacement excess count values, and determines to perform the sequential output of a predetermined number of units of data constituting the selected type of replacement data.

9. The data replacement output apparatus of claim 7, wherein
different priority levels are respectively assigned to the plurality of types of replacement data, and
the determining unit selects a type of replacement data to which the highest priority level has been assigned among one or more types of replacement data that correspond to the one or more replacement excess count values, and determines to perform the sequential output of a predetermined number of units of data constituting the selected type of replacement data.

10. The data replacement output apparatus of claim 7, wherein
a type of replacement data is pre-selected from the plurality of types of replacement data, and
if a replacement excess count value for the pre-selected type of replacement data is smaller than “0”, the determining unit selects the pre-selected type of replacement data, and
if the replacement excess count value for the pre-selected type of replacement data is no smaller than “0”, the determining unit selects a type of replacement data that corresponds to the smallest value among the one or more replacement excess count values, and
determines to perform the sequential output of a predetermined number of units of data constituting the selected type of replacement data.

11. The data replacement output apparatus of claim 6, wherein
different priority levels are respectively assigned to the plurality of types of replacement data and the non-replacement-object data,
the determining unit calculates the replacement excess count value for each pair of a type of replacement object data and a corresponding type of replacement data, and
if one or more replacement excess count values calculated by the determining unit are smaller than “0”, and if any priority level assigned to a type of replacement data corresponding to a replacement excess count value smaller than “0” is no smaller than a priority level assigned to the non-replacement-object data, the determining unit determines to perform the sequential output of a predetermined number of units of data constituting any type of replacement data corresponding to any of replacement excess count values smaller than “0”.

12. The data replacement output apparatus of claim 1, wherein
the data stream includes a plurality of types of replacement object data,
the data output unit includes
a post-replacement data storage sub-unit operable to store a plurality of types of replacement data that respectively correspond to the plurality of types of replacement object data, and
the determining unit determines whether to perform the sequential output of a predetermined number of units of data constituting any of the plurality of types of replacement data, based on a result of comparison between (i) a total number of units of data constituting the plurality of types of replacement object data that have been received during the time period and (ii) a total number of units of data constituting the plurality of types of replacement data that have been output during the time period.

13. A data replacement output apparatus for receiving a data stream composed of replacement object data and non-replacement-object data, replacing the replacement object data with replacement data, and outputting the data stream containing the replacement data, wherein
each of the replacement object data, the non-replacement-object data, and the replacement data is composed of a plurality of units of data having the same size,
the data stream contains a sequence of M units of data constituting the replacement object data,
the replacement data is composed of replacement-purpose data and dummy data,
the data replacement output apparatus comprising:
a replacement judging unit operable to judge whether a received unit of data belongs to the sequence of M units of data constituting the replacement object data or the non-replacement-object data; and
a data output unit operable to, if the replacement judging unit judges that the received unit of data belongs to the sequence of M units of data constituting the replacement object data, sequentially output N units of data constituting the replacement-purpose data and (M−N) units of data constituting the dummy data each time the sequence of M units of data is received, where M≧N, and N is an integer no smaller than “1”, and operable to, if the replacement judging unit judges that the received unit of data belongs to the non-replacement-object data, output a unit of data constituting the non-replacement-object data each time a unit of data constituting the non-replacement-object data is received.

14. A data replacement output apparatus for receiving a data stream composed of replacement object data and non-replacement-object data, replacing the replacement object data with replacement data, and outputting the data stream containing the replacement data, wherein
each of the replacement object data, the non-replacement-object data, and the replacement data is composed of a plurality of units of data having the same size,
the data stream contains a sequence of a plurality of units of data constituting the replacement object data,
the replacement data is composed of replacement-purpose data and dummy data,
the data replacement output apparatus comprising:
a replacement judging unit operable to judge whether a received unit of data belongs to the sequence of the plurality of units of data constituting the replacement object data or the non-replacement-object data;
a detecting unit operable to detect a number of units of data contained in the sequence that constitutes the replacement object data if the replacement judging unit judges that the received unit of data belongs to the sequence of the plurality of units of data constituting the replacement object data;
a judging unit operable to judge whether the number of units of data detected by the detecting unit is smaller than N, where N is an integer no smaller than “1”; and
a data output unit operable to, if the judging unit judges that the number of units of data detected by the detecting unit is smaller than N, sequentially output as much units of data constituting the dummy data as the number of units of data detected by the detecting unit each time the sequence of the plurality of units of data is received, and
operable to, if the judging unit judges that the number of units of data detected by the detecting unit is larger than N, sequentially output (i) N units of data constituting the replacement-purpose data and (ii) each time the sequence of the plurality of units of data is received, as much units of data constituting the dummy data as a difference between N and the number of units of data detected by the detecting unit, and
operable to, if the replacement judging unit judges that the received unit of data belongs to the non-replacement-object data, output a unit of data constituting the non-replacement-object data each time a unit of data constituting the non-replacement-object data is received.

15. A data replacement output method for use in a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data replacement output method comprising:
a determining step for determining whether to perform a sequential output of a predetermined number of units of data constituting the replacement data, based on a result of comparison between (i) a total number of units of data constituting the replacement object data that have been received during a time period from a reference time to a current time and (ii) a total number of units of data constituting the replacement data that have been output during the time period, the determination being made each time a unit of data constituting the replacement object data is received while the sequential output of data is not performed; and
a data output step for, if the determining step determines to perform the sequential output of data, performing the sequential output of data by outputting a unit of data constituting the replacement data each time a unit of data constituting the data stream is received, outputting a unit of data constituting the non-replacement-object data each time a unit of data constituting the non-replacement-object data is received while the sequential output of data is not performed, and if the determining step determines not to perform the sequential output of data, outputting a unit of data constituting the non-replacement-object data each time a unit of data constituting the data stream is received.

16. A data replacement output control program for use in a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data replacement output control program comprising:
a determining step for determining whether to perform a sequential output of a predetermined number of units of data constituting the replacement data, based on a result of comparison between (i) a total number of units of data constituting the replacement object data that have been received during a time period from a reference time to a current time and (ii) a total number of units of data constituting the replacement data that have been output during the time period, the determination being made each time a unit of data constituting the replacement object data is received while the sequential output of data is not performed; and
a data output step for, if the determining step determines to perform the sequential output of data, performing the sequential output of data by outputting a unit of data constituting the replacement data each time a unit of data constituting the data stream is received, outputting a unit of data constituting the non-replacement-object data each time a unit of data constituting the non-replacement-object data is received while the sequential output of data is not performed, and if the determining step determines not to perform the sequential output of data, outputting a unit of data constituting the non-replacement-object data each time a unit of data constituting the data stream is received.

17. A computer-readable recording medium recording therein a data replacement output control program for use in a data replacement output apparatus for receiving a data stream composed of replacement object data and non-replacement-object data, replacing the replacement object data with replacement data, and outputting the data stream containing the replacement data, wherein each of the replacement object data, the non-replacement-object data, and the replacement data is composed of a plurality of units of data having the same size, the data replacement output control program comprising:
a determining step for determining whether to perform a sequential output of a predetermined number of units of data constituting the replacement data, based on a result of comparison between (i) a total number of units of data constituting the replacement object data that have been received during a time period from a reference time to a current time and (ii) a total number of units of data constituting the replacement data that have been output during the time period, the determination being made each time a unit of data constituting the replacement object data is received while the sequential output of data is not performed; and
a data output step for, if the determining step determines to perform the sequential output of data, performing the sequential output of data by outputting a unit of data constituting the replacement data each time a unit of data constituting the data stream is received, outputting a unit of data constituting the non-replacement-object data each time a unit of data constituting the non-replacement-object data is received while the sequential output of data is not performed, and if the determining step determines not to perform the sequential output of data, outputting a unit of data constituting the non-replacement-object data each time a unit of data constituting the data stream is received.

18. A data replacement output method for use in a data replacement output apparatus for receiving a data stream composed of replacement object data and non-replacement-object data, replacing the replacement object data with replacement data, and outputting the data stream containing the replacement data, wherein
each of the replacement object data, the non-replacement-object data, and the replacement data is composed of a plurality of units of data having the same size,
the data stream contains a sequence of M units of data constituting the replacement object data,
the replacement data is composed of replacement-purpose data and dummy data,
the data replacement output method comprising:
a replacement judging step for judging whether a received unit of data belongs to the sequence of M units of data constituting the replacement object data or the non-replacement-object data; and
a data output step for, if the replacement judging step judges that the received unit of data belongs to the sequence of M units of data constituting the replacement object data, sequentially outputting N units of data constituting the replacement-purpose data and (M−N) units of data constituting the dummy data each time the sequence of M units of data is received, where M≧N, and N is an integer no smaller than “1”, and if the replacement judging step judges that the received unit of data belongs to the non-replacement-object data, outputting a unit of data constituting the non-replacement-object data each time a unit of data constituting the non-replacement-object data is received.

19. A data replacement output control program for use in a data replacement output apparatus for receiving a data stream composed of replacement object data and non-replacement-object data, replacing the replacement object data with replacement data, and outputting the data stream containing the replacement data, wherein
each of the replacement object data, the non-replacement-object data, and the replacement data is composed of a plurality of units of data having the same size,
the data stream contains a sequence of M units of data constituting the replacement object data,
the replacement data is composed of replacement-purpose data and dummy data,
the data replacement output control program comprising:
a replacement judging step for judging whether a received unit of data belongs to the sequence of M units of data constituting the replacement object data or the non-replacement-object data; and
a data output step for, if the replacement judging step judges that the received unit of data belongs to the sequence of M units of data constituting the replacement object data, sequentially outputting N units of data constituting the replacement-purpose data and (M−N) units of data constituting the dummy data each time the sequence of M units of data is received, where M≧N, and N is an integer no smaller than “1”, and if the replacement judging step judges that the received unit of data belongs to the non-replacement-object data, outputting a unit of data constituting the non-replacement-object data each time a unit of data constituting the non-replacement-object data is received.

20. A computer-readable recording medium recording therein a data replacement output control program for use in a data replacement output apparatus for receiving a data stream composed of replacement object data and non-replacement-object data, replacing the replacement object data with replacement data, and outputting the data stream containing the replacement data, wherein
each of the replacement object data, the non-replacement-object data, and the replacement data is composed of a plurality of units of data having the same size,
the data stream contains a sequence of M units of data constituting the replacement object data,
the replacement data is composed of replacement-purpose data and dummy data,
the data replacement output control program comprising:
a replacement judging step for judging whether a received unit of data belongs to the sequence of M units of data constituting the replacement object data or the non-replacement-object data; and
a data output step for, if the replacement judging step judges that the received unit of data belongs to the sequence of M units of data constituting the replacement object data, sequentially outputting N units of data constituting the replacement-purpose data and (M−N) units of data constituting the dummy data each time the sequence of M units of data is received, where M≧N, and N is an integer no smaller than “1”, and if the replacement judging step judges that the received unit of data belongs to the non-replacement-object data, outputting a unit of data constituting the non-replacement-object data each time a unit of data constituting the non-replacement-object data is received.

21. A data replacement output method for use in a data replacement output apparatus for receiving a data stream composed of replacement object data and non-replacement-object data, replacing the replacement object data with replacement data, and outputting the data stream containing the replacement data, wherein
each of the replacement object data, the non-replacement-object data, and the replacement data is composed of a plurality of units of data having the same size,
the data stream contains a sequence of a plurality of units of data constituting the replacement object data,
the replacement data is composed of replacement-purpose data and dummy data,
the data replacement output method comprising:
a replacement judging step for judging whether a received unit of data belongs to the sequence of the plurality of units of data constituting the replacement object data or the non-replacement-object data;
a detecting step for detecting a number of units of data contained in the sequence that constitutes the replacement object data if the replacement judging step judges that the received unit of data belongs to the sequence of the plurality of units of data constituting the replacement object data;
a judging step for judging whether the number of units of data detected in the detecting step is smaller than N, where N is an integer no smaller than “1”; and
a data output step for, if the judging step judges that the number of units of data detected in the detecting step is smaller than N, sequentially outputting as much units of data constituting the dummy data as the number of units of data detected in the detecting step each time the sequence of the plurality of units of data is received, and
if the judging step judges that the number of units of data detected in the detecting step is larger than N, sequentially outputting (i) N units of data constituting the replacement-purpose data and (ii) each time the sequence of the plurality of units of data is received, as much units of data constituting the dummy data as a difference between N and the number of units of data detected in the detecting step, and
if the replacement judging step judges that the received unit of data belongs to the non-replacement-object data, outputting a unit of data constituting the non-replacement-object data each time a unit of data constituting the non-replacement-object data is received.

22. A data replacement output control program for use in a data replacement output apparatus for receiving a data stream composed of replacement object data and non-replacement-object data, replacing the replacement object data with replacement data, and outputting the data stream containing the replacement data, wherein
each of the replacement object data, the non-replacement-object data, and the replacement data is composed of a plurality of units of data having the same size,
the data stream contains a sequence of a plurality of units of data constituting the replacement object data,
the replacement data is composed of replacement-purpose data and dummy data,
the data replacement output control program comprising:
a replacement judging step for judging whether a received unit of data belongs to the sequence of the plurality of units of data constituting the replacement object data or the non-replacement-object data;
a detecting step for detecting a number of units of data contained in the sequence that constitutes the replacement object data if the replacement judging step judges that the received unit of data belongs to the sequence of the plurality of units of data constituting the replacement object data;
a judging step for judging whether the number of units of data detected in the detecting step is smaller than N, where N is an integer no smaller than “1”; and
a data output step for, if the judging unit judges that the number of units of data detected in the detecting step is smaller than N, sequentially outputting as much units of data constituting the dummy data as the number of units of data detected in the detecting step each time the sequence of the plurality of units of data is received, and
if the judging step judges that the number of units of data detected in the detecting step is larger than N, sequentially outputting (i) N units of data constituting the replacement-purpose data and (ii) each time the sequence of the plurality of units of data is received, as much units of data constituting the dummy data as a difference between N and the number of units of data detected in the detecting step, and
if the replacement judging step judges that the received unit of data belongs to the non-replacement-object data, outputting a unit of data constituting the non-replacement-object data each time a unit of data constituting the non-replacement-object data is received.

23. A computer-readable recording medium recording therein a data replacement output control program for use in a data replacement output apparatus for receiving a data stream composed of replacement object data and non-replacement-object data, replacing the replacement object data with replacement data, and outputting the data stream containing the replacement data, wherein
each of the replacement object data, the non-replacement-object data, and the replacement data is composed of a plurality of units of data having the same size,
the data stream contains a sequence of a plurality of units of data constituting the replacement object data,
the replacement data is composed of replacement-purpose data and dummy data,
the data replacement output control program comprising:
a replacement judging step for judging whether a received unit of data belongs to the sequence of the plurality of units of data constituting the replacement object data or the non-replacement-object data;
a detecting step for detecting a number of units of data contained in the sequence that constitutes the replacement object data if the replacement judging step judges that the received unit of data belongs to the sequence of the plurality of units of data constituting the replacement object data;
a judging step for judging whether the number of units of data detected in the detecting step is smaller than N, where N is an integer no smaller than “1”; and
a data output step for, if the judging unit judges that the number of units of data detected in the detecting step is smaller than N, sequentially outputting as much units of data constituting the dummy data as the number of units of data detected in the detecting step each time the sequence of the plurality of units of data is received, and
if the judging step judges that the number of units of data detected in the detecting step is larger than N, sequentially outputting (i) N units of data constituting the replacement-purpose data and (ii) each time the sequence of the plurality of units of data is received, as much units of data constituting the dummy data as a difference between N and the number of units of data detected in the detecting step, and
if the replacement judging step judges that the received unit of data belongs to the non-replacement-object data, outputting a unit of data constituting the non-replacement-object data each time a unit of data constituting the non-replacement-object data is received.
